(19) United States
(12) Patent Application Publication
(10) Pub. No.: US 2026/0134659 A1
(43) Pub. Date: May 14, 2026

(54) SYSTEMS AND METHODS FOR AUTOMATIC DATA ANALYSIS, ORGANIZATION, AND LABELLING

(71) Applicant: SK Hynix NAND Product Solutions Corp. (dba Solidigm), Rancho Cordova, CA (US)

(72) Inventors: Rita H. WOUHAYBI, Portland, OR (US); Priyanka MUDGAL, Portland, OR (US); Samudyatha KAIRA, Portland, OR (US); Caleb MCMILLAN, Forest Grove, OR (US); Matt A. YURDANA, Portland, OR (US); August A. CAMBER, Rocklin, CA (US); Michal MAMCZYNSKI, Gdynia (PL); Marcin GLINSKI, Gdansk (PL); Dawid MILEWSKI, Banino (PL)

(21) Appl. No.: 18/945,234

(22) Filed: Nov. 12, 2024

(51) Int. Cl. G06V 10/72; G06V 10/75; G06V 10/762; G06V 10/82; G06V 10/94; G06V 20/62; G06V 20/70

(52) U.S. Cl. CPC G06V 10/72; G06V 10/751; G06V 10/7625; G06V 10/945; G06V 20/62; G06V 20/70; G06V 10/82

(57) ABSTRACT

Some embodiments are directed to systems and methods for preparing data. IN one aspect, a computer system obtains input images and groups them into image clusters including a first image cluster that includes a first set of input images. The computer system extracts image keywords from each of the first set of input images and groups the image keywords to identify a plurality of cluster keywords of the first image cluster. The computer device determines a plurality of keyword weights, each associated with a respective one cluster keyword of the plurality of cluster keywords based on cluster locations of the first set of input images in the first image cluster. The computer system labels the first set of input images based on the plurality of cluster keywords and the plurality of keyword weights.

### TECHNICAL FIELD

The present application generally relates to computer technology, and more particularly to, methods, systems, and non-transitory computer readable storage media for automatically analyzing, organizing, and labelling large data sets (e.g., using machine learning techniques).

### BACKGROUND

Edge computing brings enterprise applications closer to data sources. Enterprises today collect and generate an astounding amount of data.

### SUMMARY

Enterprises are collecting huge amounts of data at the edge. Using a warehousing environment as an example, it is very common to have sensors (e.g., cameras, motion sensors, temperature and humidity sensors, and light sensors) installed at a factory for security, safety, and process monitoring purposes. Data generated by these sensors (e.g., especially video data) can accumulate very quickly over time. In these situations, the personnel at the factory can choose to either delete the data or upload it to the cloud for archival or further analysis. However, neither of these options is ideal; the first option results in loss of data which can potentially be valuable for improving processes and can never be recovered. The second option incurs high costs in terms of power, network, storage, and compute. On the other hand, not all data is valuable. Using cameras installed in a factory as an example, it is likely that most of the video streams collected by the cameras contain routine and uneventful information. Although solutions for data ranking and/or reduction exist today, they tend to require user intervention and are very tedious and cognitively demanding. Furthermore, there is no one-size-fits-all definition that defines what constitutes “valuable” data means. What constitutes “valuable” data depends on the user and the usage scenario.

In view of the aforementioned reasons, there is a need for systems and methods that are configured to rank data according to its potential value, without user intervention (or with minimal user intervention), so that enterprises can act on the data accordingly.

Some embodiments of the present disclosure are directed to methods, systems, and non-transitory computer readable storage media for automatically preparing (e.g., analyzing, organizing, and labelling) data using an artificial intelligence (AI) processing pipeline. In some embodiments, automatic data preparation includes self-organizing and self-labeling of data using the disclosed AI pipeline automatically and without user intervention, as the data is being collected and/or after it has been collected (e.g., while held in storage). In some embodiments, the disclosed methods and systems are directed to data that are obtained from a physical environment. Exemplary data can include sensor readings from physical processes or video streams from imaging devices. In some embodiments, the obtained data is pre-processed by identifying and removing redundant data, to obtain a reduced dataset.

In some embodiments, information (e.g., embedding features/variables, latent features/variables, etc.) and context are extracted from the dataset using a machine learning technique, such as embedding extraction, high-level feature extraction, or low-level feature extraction. The AI processing pipeline may determine an optimum number of clusters (e.g., groups) based on the extracted information. In some embodiments, the extracted information is further organized using a clustering technique, such as k-means clustering, density-based spatial clustering of applications with noise (DBSCAN), and Gaussian mixture models (GMM) clustering. In some embodiments, the AI processing pipeline generates keywords on a respective cluster using an image-to-text technique, such as image caption generator, image descriptor, or text summarization. In some embodiments, keywords are grouped semantically and contextually to identify a set of relevant keywords. In some embodiments, labels are determined for the data with their detected location in images. In some embodiments, the AI processing pipeline provides one or more graphical user interfaces (GUIs) that facilitate user navigation of data groups (e.g., image clusters), keywords, metadata, and annotations of the dataset.

In some embodiments, after the data has been organized and/or labeled, it can be applied in different usage scenarios depending on a user's needs. For example, the organized and/or labeled data can be used to generate training datasets, train AI models, detect events, identify objects, generate data summaries, highlight unexpected results, or identify outliers. Thus, the disclosed AI processing pipeline addresses the conundrum of what the definition of valuable data is, by providing a comprehensive and robust technical solution that enables users to slice and dice data in a multitude of different ways.

In accordance with some embodiments, the technical solutions disclosed advantageously distinguish over existing data ranking and/or reduction solutions at least by preparing (e.g., organizing and labeling) data for subsequent use with minimal user intervention. As disclosed, the AI processing pipeline includes a data management application with a GUI, which provides a convenient and user-friendly way for a user to view, explore, and navigate data corresponding to activities in the physical environment. As disclosed, the data can also be used to feed other processes such as business intelligence over multiple days/weeks or across different locations. This data can be used for multiple purposes such as generating data summaries, training AI models, and detecting events and anomalies.

In one aspect, a method for preparing data is implemented at a computer system having one or more processors and memory. The method includes obtaining a plurality of input images captured by one or more imaging devices. The method includes grouping the plurality of input images into a plurality of image clusters including a first image cluster, the first image cluster including a first set of input images. The method includes extracting one or more image keywords from each of the first set of input images. The method includes grouping the one or more image keywords of each of the first set of input images to identify a plurality of cluster keywords of the first image cluster. The method includes determining a plurality of keyword weights. Each of the keyword weights is associated with a respective one cluster keyword of the plurality of cluster keywords based on cluster locations of the first set of input images in the first image cluster. The method also includes labelling the first set of input images based on the plurality of cluster keywords and the plurality of keyword weights.

In some embodiments, the method includes forming a corpus of training data to be used to generate a target model. The corpus of training data includes the first set of input images, each of which is labeled based on the plurality of cluster keywords and the plurality of keyword weights.

In some embodiments, the method includes, for each of the first set of input images, applying an image text association model to select a respective one of the plurality of cluster keywords. The method includes forming a corpus of training data to be used to generate a target model. The corpus of training data includes the first set of input images, each of which is labeled with the selected respective one of the plurality of cluster keywords.

In some embodiments, the method includes determining a plurality of feature events or objects of the first image cluster based on the plurality of cluster keywords; and determining a plurality of occurrence rates of the plurality of feature events or objects based on the plurality of keyword weights.

In some embodiments, a first cluster keyword corresponds to a respective image keyword of each input image in a subset of the first set of input images. The method further comprises determining an image weight for each input image of the subset of the first set of input images based on a cluster location of the respective input image in the first image cluster, where a keyword weight of the first cluster keyword is determined based on the image weight of each input image of the subset of the first set of input images.

In some embodiments, the method includes determining a keyword confidence level for the respective image keyword of each of the subset of the first set of input image, where the keyword weight of the first cluster keyword is determined based on a combination of the image weight and the keyword confidence level of the image keyword of each input image of the subset of the first set of input images.

In some embodiments, a first cluster keyword is associated with a subset of the first set of input images. The method further comprises identifying a visual location associated with the first cluster keyword in each of the subset of the first set of input images; and labelling each of the subset of the first set of input images with the visual location in addition to the first cluster keyword and an associated keyword weight.

In some embodiments, grouping the plurality of input images into the plurality of image clusters includes extracting an image embedding for each of the plurality of input images; and clustering the plurality of input images into the plurality of image clusters based on a plurality of image embeddings of the plurality of input images, where each image cluster has a respective most representative image and a respective boundary.

In some embodiments, grouping the plurality of input images into the plurality of image clusters includes identifying a target number indicating a number of image clusters to which the plurality of image clusters belong; applying a plurality of clustering methods to generate a plurality of sets of image clusters based on the plurality of input images, each clustering method corresponding to a respective set of image clusters; determining a plurality of clustering performance indicators for the plurality of clustering methods; and based on the plurality of clustering performance indicators, selecting one of the plurality of sets of image clusters as the plurality of image clusters.

In some embodiments, grouping the one or more image keywords of each of the first set of input images to identify the plurality of cluster keywords of the first image cluster further comprises: generating a collection of image keywords based on the one or more image keywords of each of the first set of input images; and eliminating a set of redundant keywords in the collection of image keywords to identify the plurality of cluster keywords.

In some embodiments, obtaining a plurality of input images further comprises: obtaining a plurality of image frames; and implementing at least one of a plurality of operations including (i) in accordance with a determination that a first set of image frames are substantially similar in brightness or in contrast, including a subset of the first set of image frames in the plurality of input images; and (ii) in accordance with a determination that a movement of an object is within a tolerance in a second set of image frames, including a subset of the second set of image frames in the plurality of input images.

In some embodiments, obtaining a plurality of input images further includes obtaining a plurality of image frames; applying one of pixel-level image comparison, feature-based matching, and block-based matching to identify a third set of image frames that are substantially similar to one another; and generating one of the plurality of input images based on the third set of image frames.

In some embodiments, the method further comprises: executing an image management application, including displaying a visualization user interface; receiving a first user interaction, with the visualization user interface, identifying one or more of the plurality of cluster keywords; and in accordance with receiving the first user interaction, displaying, on the visualization user interface, a plurality of image representations corresponding to a first subset of the first set of input images, the plurality of image representations organized based on the one or more of the plurality of cluster keywords.

In some embodiments, the method further comprises: executing an image management application, including displaying a visualization user interface; receiving, via the visualization user interface, first user input identifying at least one of: a number of images and an image similarity level; and in accordance with receiving the first user input, displaying, on the visualization user interface, a plurality of image representations corresponding to a subset of the first set of input images and organized based on a respective cluster location of each input image

In another aspect, a method for preparing data is implemented at a computer system having one or more processors and memory. The method includes obtaining a plurality of input images. The method includes grouping the plurality of input images into a plurality of image clusters including a first image cluster. The first image cluster includes a first set of input images. The method includes, for the first image cluster: (i) identifying a representative image; (ii) determining one or more events according to a similarity level between input images belonging to other image clusters and the representative image; (iii) selecting a subset of input images based on the similarity level; and (iv) labelling each of the subset of input images with a respective feature label. The method also includes forming a corpus of training data to be used to train a target model. The corpus of training data includes the subset of input images each labeled with a respective feature label.

According to another aspect of the present application, a computer system includes one or more processors and memory. The memory stores instructions that, when executed by the one or more processors, cause the computer system to perform any of the methods for preparing data as disclosed herein.

According to another aspect of the present application, a non-transitory computer readable storage medium stores instructions configured for execution by a computer system that includes one or more processors and memory. The instructions, when executed by the one or more processors, cause the computer system to perform any of the methods for preparing data as disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The accompanying drawings, which are included to provide a further understanding of the embodiments, are incorporated herein, constitute a part of the specification, illustrate the described embodiments, and, together with the description, serve to explain the underlying principles.

FIG. 1 depicts a representative smart work environment, in accordance with some implementations.

FIG. 2 is an example operating environment in which a smart device interacts with a client device or a server system, in accordance with some implementations.

FIG. 3 is a block diagram illustrating a computer system of a smart work environment, in accordance with some implementations.

FIG. 4 is a block diagram of a machine learning system for training and applying data processing models using machine learning, in accordance with some embodiments.

FIG. 5A is a structural diagram of an example neural network applied to process work data in a data processing model, in accordance with some embodiments.

FIG. 5B is an example node in the neural network, in accordance with some embodiments.

FIGS. 6A and 6B illustrate example workflows for preparing data, in accordance with some embodiments.

FIG. 7A illustrates an image clustering workflow, in accordance with some embodiments.

FIG. 7B illustrates an example image cluster, in accordance with some embodiments.

FIG. 8 illustrates an embedding model that encapsulates information from images into embedding vectors, in accordance with some embodiments.

FIG. 9 illustrates a keyword extraction and metadata grouping process, in accordance with some embodiments.

FIGS. 10A to 10F illustrate example graphical user interfaces (GUIs) for navigating clusters of images, keywords, and metadata, in accordance with some embodiments.

FIGS. 11A to 11G provide a flow diagram of an example method for preparing data, in accordance with some embodiments.

FIG. 12 provides a flow diagram of an example method for automatically identifying characteristic features in data, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

Various embodiments of the present disclosure are directed to AI pipelines for automatically preparing data without (or with minimal) user intervention. In some embodiments, data preparation includes executing, by a computer system, an AI pipeline that automatically organizes and/or labels data without user input or intervention. In some embodiments, the auto-organizing and auto-labeling can be applied to the data that are obtained in the same session or from different sessions (e.g., at different times). In some embodiments, the auto-organizing and auto-labeling can be applied to newly obtained data or to update an existing (e.g., prior processed) dataset. In accordance with some embodiments of the present disclosure, a computer system includes one or more processors and memory. The computer system obtains a plurality of input images captured by one or more imaging devices. In some embodiments, the computer system obtains input data such as time-series data or text data. In some embodiments, the computer system obtains the plurality of input images by obtaining a plurality of image frames and performing an initial reduction on the plurality of image frames. For example, in some embodiments, the computer device, in accordance with a determination that a first set of image frames (e.g., consecutive or successive image frames) are substantially similar in brightness or in contrast, includes a subset (i.e., less than all) of the first set of image frames in the plurality of input images. In some embodiments, the computer device, in accordance with a determination that a movement of an object is within a tolerance (e.g., tolerance distance, threshold distance) in a second set of image frames, includes a subset (i.e., less than all) of the second set of image frames in the plurality of input images. In some embodiments, the computer system applies at least one of: pixel-level image comparison, feature-based matching, and block-based matching, to identify a third set of image frames that are substantially similar to one another and generate one of the plurality of input images based on the third set of image frames.

The computer system groups (e.g., organizes) the plurality of input images into a plurality of image clusters, including a first image cluster. The first image cluster includes a first set of input images. In some embodiments, the first set of input images comprises at least 10,000 images, at least 50,000 images, or at least 100,000 images. In some embodiments, the computer system groups the plurality of input images into a plurality of image clusters by applying embedding-based grouping techniques. For example, in some embodiments, the computer system extracts an image embedding for each of the plurality of input images and clusters the plurality of input images into the plurality of image clusters based on a plurality of image embeddings of the plurality of input images, where each image cluster has a respective most representative image and a respective boundary. In situations where the input data includes other data types such as time-series data and text data, the computer system can extract graph embeddings, numerical embeddings, and text embeddings. In some embodiments, the computer system groups the plurality of input images into a plurality of image clusters by applying clustering methods (e.g., centroid-based methods) and performance indicator metrics (e.g., how well a clustering algorithm groups the images into clusters), For example, in some embodiments, the computer system identifies a target number indicating a number of image clusters to which the plurality of image clusters belong; applies a plurality of clustering methods to generate a plurality of sets of image clusters based on the plurality of input images, where each clustering method corresponds to a respective set of image clusters; determines a plurality of clustering performance indicators for the plurality of clustering methods; and based on the plurality of clustering performance indicators, selects one of the plurality of sets of image clusters as the plurality of image clusters.

The computer system extracts one or more image keywords from each of the first set of input images. In some embodiments, the computer system extracts one or more image keywords from a succession of images (e.g., that depict movement). In some embodiments, for the first image cluster including the first set of input images, extracting the one or more image keywords from each of the first set of input images includes generating description of the respective input image and extracting the one or more image keywords from the description of the respective input image.

The computer system groups (e.g., merges) the one or more image keywords of each of the first set of input images to identify a plurality of cluster keywords of the first image cluster. In some embodiments, grouping the one or more image keywords includes generating a collection of image keywords based on the one or more image keywords of each of the first set of input images and eliminating a set of redundant keywords (and/or similar keywords) in the collection of image keywords to identify the plurality of cluster keywords.

The computer system determines a plurality of keyword weights. Each keyword weight is associated with a respective one cluster keyword of the plurality of cluster keywords based on cluster locations of the first set of input images in the first image cluster. The computer system labels (e.g., associates, causes labeling of, annotates, or causes annotation of) the first set of input images based on the plurality of cluster keywords and the plurality of keyword weights. In some embodiments, the computer device forms a corpus of training data to be used to generate a target model (e.g., for autonomously monitoring a physical environment). The corpus of training data includes the first set of input images, each of which is labeled based on the plurality of cluster keywords and the plurality of keyword weights. In some embodiments, for each of the first set of input images, the computer system applies an image text association model to select a respective one of the plurality of cluster keywords and forms a corpus of training data to be used to generate a target model (e.g., for autonomously monitoring the physical environment). The corpus of training data includes the first set of input images, each of which is labeled with the selected respective one of the plurality of cluster keywords.

In some embodiments, the computer system executes an image management application, including displaying (or causing display of) a visualization user interface. In some embodiments, the computer system receives a first user interaction, with the visualization user interface, identifying (e.g., specifying) one or more of the plurality of cluster keywords. In some embodiments, the computer system, in accordance with receiving the first user interaction, displays (or causes display), on the visualization user interface, a plurality of image representations corresponding to a first subset of the first set of input images, where the plurality of image representations are organized based on the one or more of the plurality of cluster keywords. In some embodiments, the computer system executes an image management application, including displaying (or causing displaying of) a visualization user interface. The computer system receives, via the visualization user interface, first user input identifying at least one of a number of images and an image similarity level. In some embodiments, the computer system. in accordance with receiving the first user input, displays (or causes display), on the visualization user interface, a plurality of image representations corresponding to a subset of the first set of input images and organized based on a respective cluster location of each input image.

In accordance with some embodiments of the present disclosure, a computer system includes one or more processors and memory. The computer system obtains a plurality of input images. The computer system groups the plurality of input images into a plurality of image clusters, including a first image cluster. The first image cluster including a first set of input images. For the first image cluster, the computer system (i) identifies a representative image (e.g., a most representative image or an image at a centroid (or near a centroid) of an image cluster); (ii) determines one or more events (e.g., outliers, unique events, or representative events) according to a similarity level (e.g., more similar or less similar) between input images belonging to other image clusters and the centroid input image; (iii) selects a subset of input images based on the similarity level; and (iv) labels each of the subset of input images with a respective feature label. The computer system forms a corpus of training data to be used to train a target model (e.g., for autonomously monitoring the physical environment). The corpus of training data includes the plurality of input images each labeled with a respective feature label.

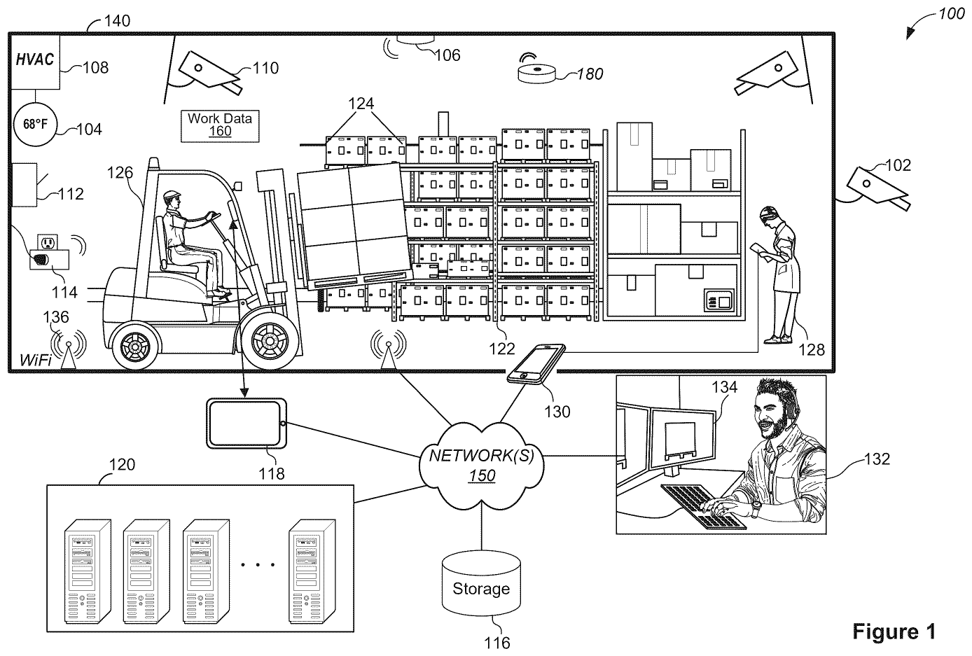

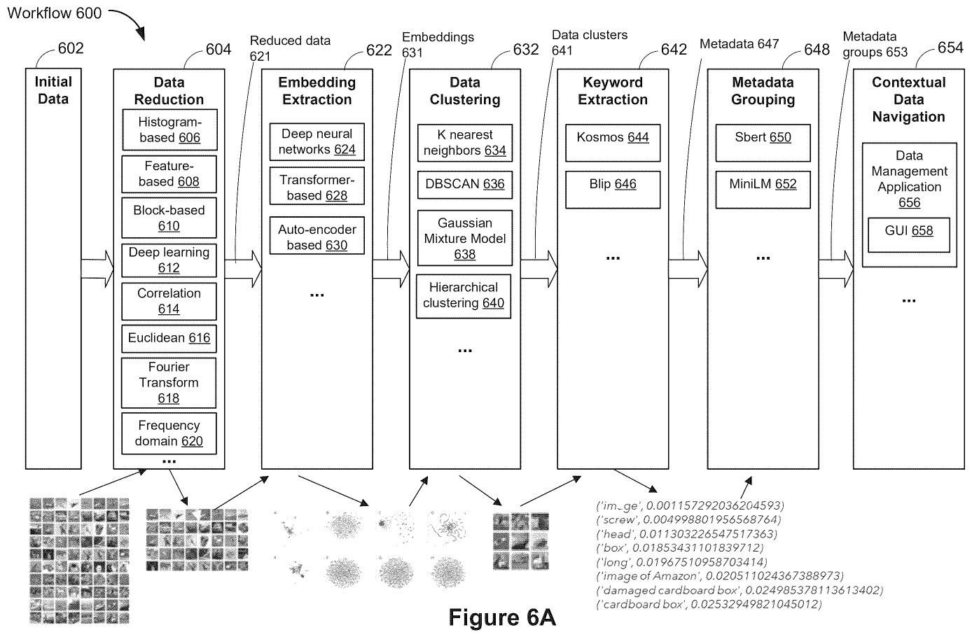

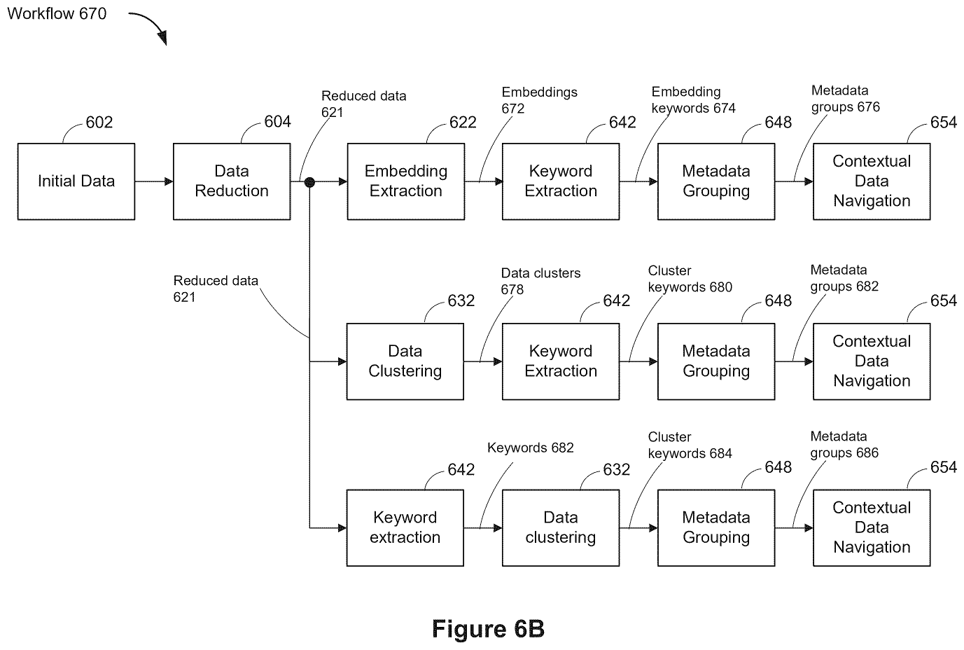

FIGS. 1-5B provide background exemplary sensor device networks and capabilities (e.g., machine learning based data processing capabilities) described herein, which are helpful in understanding the details of the embodiments described from FIG. 6 onward.

FIG. 1 depicts a representative smart work environment 100 in accordance with some implementations. The smart work environment 100 includes a structure 140, which may be used as a warehouse, factory, construction site, farm, laboratory, office space, retail store, hospital, and the like. For example, the structure 140 may be used as a distribution center, an e-commerce fulfillment center, an automobile assembly plant, an electronics manufacturing facility, a supermarket, or a retailer store. It will be appreciated that the structure 140 has an open floor plan, high ceilings, and support structures (e.g. columns or beams) and may include different functional areas designed for efficiency, safety, and scalability. Further, the smart work environment 100 may control and/or be coupled to devices outside of the actual structure 140. Indeed, several devices in the smart work environment 100 need not be physically within the structure 140. For example, a surveillance camera 102 may be located outside of the structure 140.

The depicted structure 140 may include a plurality of areas (e.g., storage areas, work areas) that may not be physically separated by walls. The depicted structure 140 may also include rooms (not shown) that are separated from the plurality of areas by walls. Devices may be mounted on, integrated with, and/or supported by a wall, a floor, a ceiling, or a support structure of the structure 140. Alternatively, devices may be mounted on, integrated with, and/or supported by an object (e.g., a shelf 122, a forklift 126) fixed or moveable in the structure 140.

In some implementations, the smart work environment 100 includes a plurality of devices, including intelligent, multi-sensing, network-connected devices, that integrate seamlessly with each other in a network 150 and/or with a central server system 120 or a cloud-computing system to provide a variety of useful smart work functions. The smart work environment 100 may include one or more surveillance cameras 102, one or more intelligent, multi-sensing, network-connected thermostats 104 (“smart thermostats”) and one or more intelligent, network-connected, multi-sensing hazard detection units 106 (“smart hazard detectors”). In some implementations, the smart thermostat 104 detects ambient climate characteristics (e.g., temperature and/or humidity) and controls an HVAC system 108 accordingly. The smart hazard detector 106 may detect the presence of a hazardous substance or a substance indicative of a hazardous substance (e.g., smoke, fire, and/or carbon monoxide). The surveillance cameras 102 may detect a person's or a vehicle's approach to or departure from the structure 140, identify and/or report any abnormal incidents, and/or control settings on a security system (e.g., to activate or deactivate the security system).

In some implementations, the smart work environment 100 includes one or more intelligent, multi-sensing, network-connected wall switches 112 (“smart wall switches”), along with one or more intelligent, multi-sensing, network-connected wall plug interfaces 114 (“smart wall plugs”). The smart wall switches 112 may detect ambient lighting conditions, detect room-occupancy states, and control a power and/or dim state of one or more lights. In some instances, smart wall switches 112 may also control a power state or speed of a fan, such as a ceiling fan. The smart wall plugs 114 may detect occupancy of a room or enclosure and control supply of power to one or more wall plugs (e.g., such that power is not supplied to the plug if nobody is present in the structure 140).

In some implementations, the smart work environment 100 includes a plurality of network-connected cameras 110 that are configured to provide video monitoring and security inside the structure 140. For example, the structure 140 is used as a warehouse, which is a bustling hub of activity, with neatly organized shelves 122 stretching high to accommodate an extensive inventory of product boxes 124. Each shelf 122 is carefully labeled and arranged to maximize space and ensure efficient access to goods. A forklift 126 may navigate the wide aisles with precision, lifting and moving boxes 124 from one location to another with a steady hum of its engine. The forklift 126 may include a computer device 118 for obtaining and updating information of the boxes 124 (e.g., box locations, weights, handling details). A worker 128 may check the stock levels on a handheld device 130, verifying the quantities and ensuring that inventory records match the physical stock. The air is filled with the sounds of the forklift's beeping and the occasional rustle of boxes as the warehouse maintains a routine of receiving, storing, and preparing products for distribution. A plurality of cameras 110 are distributed at different locations in the structure 140, and configured to capture static images or video clips monitoring activities of the forklift 126 and the worker 128.

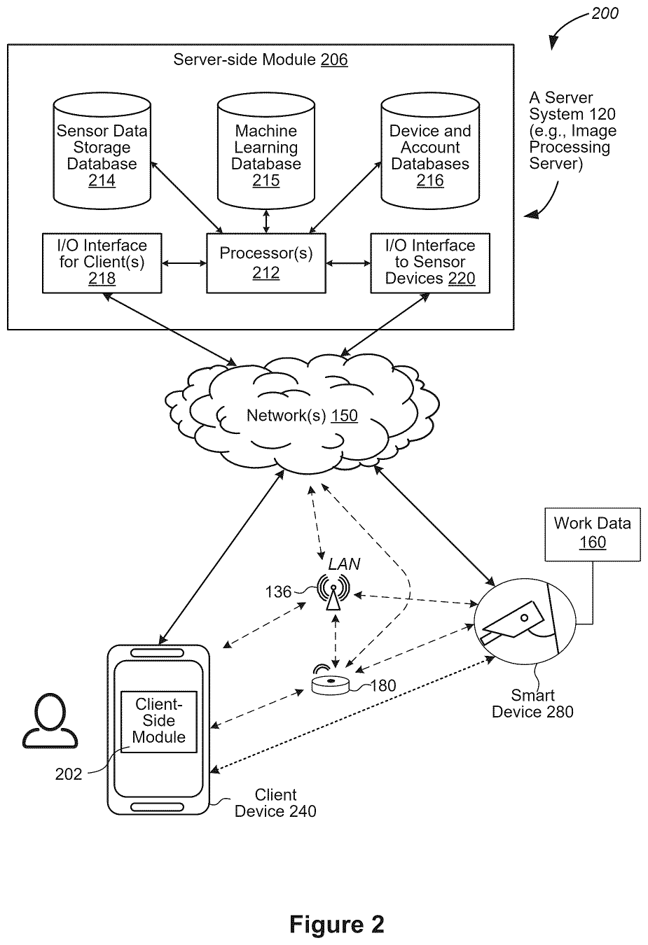

The devices 102-114 (e.g., collectively called smart devices 280 in FIG. 2) are examples of sensors and actuators that are disposed in the smart work environment 100 for collecting work data 160 (e.g., image data captured by cameras 110, temperature data captured by the smart thermostat 104). In some embodiments now shown, a variety of smart devices 280 are used to optimize efficiency and ensure smooth operations in the smart work environment 100. For example, radio frequency identification (RFID) sensors are employed to track products throughout the structure 140, ensuring that items are accurately located and inventoried. Proximity sensors may help robots and autonomous vehicles navigate safely by detecting obstacles and other machines. Infrared and optical sensors are used for barcode scanning, enabling quick identification of products. Additionally, pressure and weight sensors ensure that items are handled carefully and that shipping weights are accurate. Additional environmental sensors monitor conditions such as humidity to protect sensitive products. These technologies work together to create a highly automated and efficient smart work environment 100.

By virtue of network connectivity, one or more of the smart devices 280 may further allow a user to interact with the devices even if a user 132 is not proximate to the devices For example, the user 132 may communicate with a device using a computer device 134 (e.g., a desktop computer, laptop computer, a tablet computer, or other portable electronic device (e.g., a smartphone)). A webpage or application may be configured to receive communications from the user 132 and control the smart devices 280 based on the communications and/or to present information about the device's operation to the user 132. For example, the user 132 may view a current set point temperature for the smart thermostat 104 and adjust it using the computer device 134. The user 132 may review signature events captured by the camera 110 or adjust settings of the camera 110 using the computer device 134. The user 132 may be physically located within or outside the structure 140 during this remote communication.

As discussed above, users may control the smart thermostat 104 and other smart devices in the smart work environment 100 using a network-connected computer device 134. In some examples, a plurality of employees of a business entity associated with the structure 140 may register their devices 134 with the smart work environment 100. Such registration may be made at a central server 120 to authenticate the employees and/or the devices 134 as being associated with the structure 140 and to give permission to the employees to use the devices 134 to access the smart devices 280 in the structure 140. Employees may use their registered devices 134 to remotely control the smart devices 280 of the structure 140, e.g., when an employee is at work, on vacation, or at a separate office location. The employee may also use a registered device 134 (e.g., handheld device 130) to control the smart devices 280 when the employee is actually located inside the structure 140, such as when the employee is checking stocking in the warehouse.

In some implementations, in addition to containing processing and sensing capabilities, the devices 102, 104, 106, 108, 110, 112, and/or 114 (“the smart devices”) are capable of data communications and information sharing with other smart devices, a central server or cloud-computing system, and/or other devices that are network-connected. The required data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any of a variety of custom or standard wired protocols (e.g., CAT6 Ethernet or HomePlug), or any other suitable communication protocol.

In some implementations, the smart devices 280 serve as wireless or wired repeaters. For example, a first one of the smart devices communicates with a second one of the smart devices via a wireless router. The smart devices may further communicate with each other via a connection to one or more networks 150 such as the Internet. Through the one or more networks 150, the smart devices may communicate with a smart work server system 120 (also called a central server system and/or a cloud-computing system herein). In some implementations, the smart work server system 120 may include multiple server systems, each dedicated to data processing associated with a respective subset of the smart devices (e.g., a video server system may be dedicated to data processing associated with camera(s) 110). The smart work server system 120 may be associated with a manufacturer, support entity, or service provider associated with the smart devices 280. In some implementations, the smart work environment 100 relies on a dedicated hub device 180 to manage smart devices 280 located within the smart work environment 100, and a hub device server system associated with the hub device 180 serves as the server system 120.

In some implementations, a user is able to contact customer support using a smart device itself rather than needing to use other communication means, such as a telephone or Internet-connected computer. In some implementations, software updates are automatically sent from the smart work server system 120 to smart devices 280 (e.g., when available, when purchased, or at routine intervals). In some embodiments, the smart work environment 100 further includes a storage 116 for storing data related to the servers 120, smart devices 280, client devices 118, 130, and 134 (e.g., collectively called client device 240 in FIG. 2), and applications executed on the client devices. In some embodiments, the storage 116 includes a plurality of SSDs.

FIG. 2 is an example operating environment 100 in which a smart device 280 (e.g., cameras 110) interacts with a client device 240 (e.g., devices 118, 130, and 134 in FIG. 1) or a server system 120 (e.g., an image processing server), in accordance with some implementations. In the operating environment 200, the server system 120 provides data processing for monitoring and facilitating review of object location/motion associated with imaging device data streams (e.g., raw or processed work data 160) captured by multiple cameras 110 disposed in the structure 140. As shown in FIG. 2, the server system 120 may receive raw or processed work data 160 from smart devices 280 (standalone or integrated) located at various physical locations in the smart work environments 100. Each smart device 280 may be bound to one or more reviewer accounts, and the server system 120 may further process the received work data 160 to obtain information associated with the smart device 280 and the corresponding reviewer accounts. For a camera 110, the obtained information could be object locations, object movements, user gestures, and depth mapping. In some implementations, the server system 120 provides the information to client devices 240 associated with the reviewer accounts. In some implementations, the server system 120 uses the information to control a smart device 280 linked to the reviewer accounts.

In some implementations, the server system 120 is a dedicated image processing server that provides data processing services to cameras 110 and client devices 240 independently of other services provided by the server system 120.

In some implementations, each of the smart devices 280 captures work data 160 using signal detectors and sends the captured work data 160 to the server system 120 substantially in real time. In some implementations, each of the smart devices 280 includes a controller device (e.g., a smart device in which a camera 110 is integrated) that serves as an intermediary between the smart device 280 and the server system 120. The controller device receives the work data 160 from the one or more smart devices 280, optionally performs some preliminary processing on the work data 160, and sends the processed work data 160 to the server system 120 on behalf of the one or more smart devices 280 substantially in real time. In some implementations, each smart device 280 has its own on-board processing capabilities to perform some preliminary processing on the captured work data 160 before sending the processed work data 160 (along with metadata obtained through the preliminary processing) to the controller device and/or the server system 120. In some implementations, the client device 240 located in the smart work environment 100 functions as the controller device to at least partially process the captured work data 160.

In accordance with some implementations, each of the client devices 240 includes a client-side module 202. The client-side module 202 communicates with a server-side module 206 executed on the server system 120 through the one or more networks 150. The client-side module 202 provides client-side functionality for information monitoring, review processing, and communication with the server-side module 206. The server-side module 206 provides server-side functionality for event monitoring and review processing for any number of client-side modules 202, each residing on a respective client device 240. The server-side module 206 also provides server-side functionality for response processing and device control for any number of the smart devices 280.

In some implementations, the server-side module 206 includes one or more processors 212, a sensor data database 214, machine learning database 215, device and account databases 216, an I/O interface 218 to one or more client devices, and an I/O interface 220 to one or more smart devices 280. The I/O interface 218 to one or more clients facilitates the client-facing input and output processing for the server-side module 206. The device and account databases 216 store a plurality of profiles for reviewer accounts registered with the server system 120. A user profile includes account credentials for each reviewer account, and identifies one or more smart devices 280 linked to the reviewer account. In some implementations, the user profile of each reviewer account includes information related to capabilities, device characteristics, and lookup tables for the smart devices 280 linked to the reviewer account. The I/O interface 220 to one or more imaging devices facilitates communications with one or more smart devices 280 (standalone or integrated). The sensor data storage database 214 stores raw or processed work data 160 received from the smart devices 280 and associated information, as well as various types of metadata, such as device characteristics of signal emitters and detectors, lookup tables, modulation signals, and sampling rates. In some implementations, this data is used for generating additional information associated with each reviewer account. The machine learning database 215 stores data used by the server 120, the smart devices 280, or the client devices 240 to process the work data 160 collected by the smart devices 280 based on machine learning. For example, machine learning based data processing models and associated training data are stored in the machine learning database 215.

Client devices 240 include handheld computers, wearable computing devices, personal digital assistants (PDAs), tablet computers, laptop computers, desktop computers, cellular telephones, smart phones, enhanced general packet radio service (EGPRS) mobile phones, media players, navigation devices, game consoles, televisions, remote controls, point-of-sale (POS) terminals, vehicle-mounted computers, ebook readers, or a combination of any two or more of these data processing devices or other data processing devices.

Examples of the one or more networks 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 120 is implemented on one or more standalone data processing devices or a distributed network of computers. In some implementations, the server system 120 employs various virtual devices and/or services of third party service providers (e.g., third-party cloud service providers) to provide the underlying computing resources and/or infrastructure resources of the server system 120. In some implementations, the server system 120 includes handheld computers, tablet computers, laptop computers, desktop computers, or a combination of any two or more of these data processing devices or other data processing devices.

The server-client environment 200 shown in FIG. 2 includes both a client-side portion (e.g., the client-side module 202) and a server-side portion (e.g., the server-side module 206). The division of functionality between the client and server portions of operating environment 200 can vary in different implementations. Similarly, the division of functionality between the smart devices 280 and the server system 120 can vary in different implementations. In some implementations, the client-side module 202 is a thin-client that provides only user-facing input and output processing functions, and delegates other data processing functionality to a backend server (e.g., the server system 120). In some implementations, a smart device 280 is a simple data capturing device that continuously captures and streams work data 160 to the server system 120, with limited local preliminary processing of the data. Although many aspects of the present technology are described from the perspective of a computer system (e.g., system 300) as a whole, the corresponding actions performed by the client device 240 and/or the server system 120 would be apparent to those of skill in the art. Some aspects of the present technology may be described from the perspective of the client device or the server system, and the corresponding actions performed by the server system would be apparent to those of skill in the art. Furthermore, some aspects of the present technology may be performed by the server system 120, the client device 240, and the smart device 280 cooperatively.

It should be understood that the operating environment 200 that involves the server system 120, the client device 240, and the smart device 240 is merely an example. Many aspects of operating environment 200 are generally applicable in other operating environments in which a server system provides data processing for monitoring and facilitating review of data captured by other types of electronic devices.

The smart devices, the client devices, and the server system communicate with each other using the one or more communication networks 150. In an example smart work environment 100, two or more devices (e.g., the network interface device 136, the hub device 180, the client devices 240, and the smart devices 280) are located in close proximity to each other, such that they can be communicatively coupled in the same sub-network via wired connections, a WLAN, or a Bluetooth Personal Area Network (PAN). The Bluetooth PAN is optionally established based on classical Bluetooth technology or Bluetooth Low Energy (BLE) technology. In some implementations, each of the hub device 180, the client device 240, and the smart devices 204 are communicatively coupled to the networks 150 via the network interface device 136.

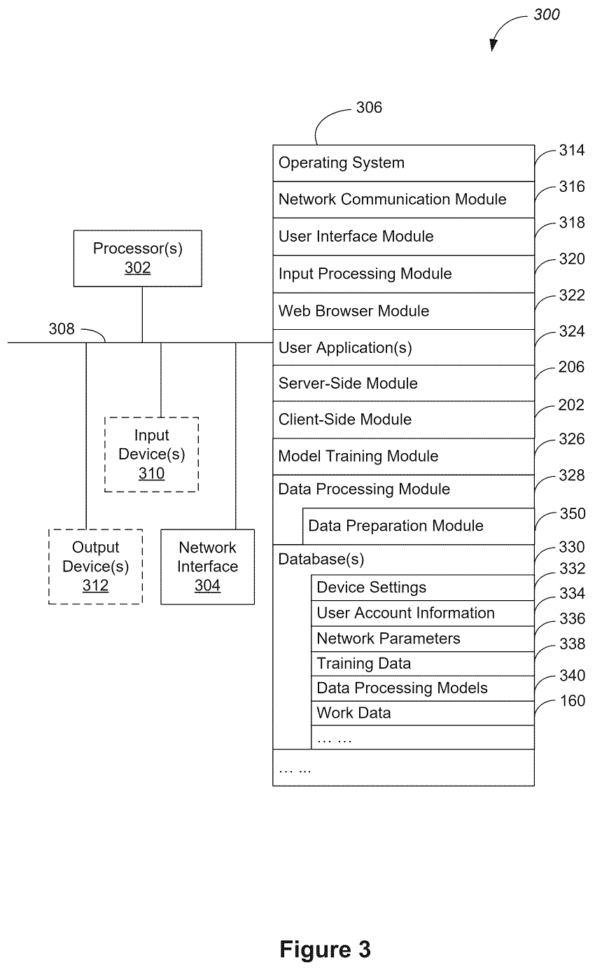

FIG. 3 is a block diagram illustrating a computer system 300 of a smart work environment 100 in accordance with some implementations. The computer system 300 includes a server 120, a client device 240 (e.g., computer device 118, 130, or 134 in FIG. 1), a smart device 280 (e.g., devices 102-114 in FIG. 1), a storage 116, or a combination thereof, and is configured to enable the smart work environment 100. The computer system 300 includes one or more processing units (CPUs) 302, one or more network interfaces 304, memory 306, and one or more communication buses 308 for interconnecting these components (sometimes called a chipset). In some implementations, the computer system 300 includes one or more input devices 310, which facilitate user input, such as a keyboard, a mouse, a voice-command input unit or microphone, a touch screen display, a touch-sensitive input pad, a gesture capturing camera, or other input buttons or controls. In some implementations, the computer system 300 uses a microphone and voice recognition or a camera and gesture recognition to supplement or replace the keyboard. In some implementations, the computer system 300 includes one or more cameras, scanners, or photo sensor units for capturing images. In some implementations, the computer system 300 includes one or more output devices 312, which enable presentation of user interfaces and display content, including one or more speakers and/or one or more visual displays.

The memory 306 includes high-speed random access memory, such as DRAM, SRAM, DDR RAM, or other random access solid state memory devices. In some implementations, the memory 306 includes non-volatile memory, such as one or more magnetic disk storage devices, one or more optical disk storage devices, one or more flash memory devices, or one or more other non-volatile solid state storage devices. In some implementations, the memory 306 includes one or more storage devices remotely located from the processing units 302. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof:
an operating system 314, which includes procedures for handling various basic system services and for performing hardware dependent tasks;
a network communication module 316, which connects the computer system 300 to other devices (e.g., various servers in the server system 120, a client device, or a smart device) via one or more network interfaces 304 (wired or wireless) and one or more networks 150, such as the Internet, other wide area networks, local area networks, metropolitan area networks, and so on;
a user interface module 318, which enables presentation of information (e.g., a graphical user interface for presenting applications, widgets, websites and web pages thereof, and/or games, audio and/or video content) at a client device 118, 130, and 134;
an input processing module 320 for detecting one or more user inputs or interactions from one of the one or more input devices 310 and interpreting the detected input or interaction;
a web browser module 322 for navigating, requesting (e.g., via HTTP), and displaying websites and web pages thereof, including a web interface for logging into a user account associated with a client device 240 or another electronic device, controlling the client or electronic device if associated with the user account, and editing and reviewing settings and data that are associated with the user account;
one or more user applications 324 for execution by the servers 120 (e.g., smart work applications, and/or other web or non-web based applications);
a server-side module 206, which communicates both with smart work environments 100 and with client-side modules 202 and includes a plurality of individual programs, procedures, modules, and/or objects for performing a variety of functions;
a client-side module 202, which communicates with the server-side module 206 in the smart work environment 100 and includes a plurality of individual programs, procedures, modules, and/or objects for performing a variety of functions;
model training module 326 for receiving training data and establishing one or more data processing models 340 for processing work data 160 (e.g., video, image, audio, or textual data) collected by the smart devices 280;
a data processing module 328 for processing work data 160 using data processing models 340, thereby identifying information contained in the work data 160, matching the work data 160 with other data, categorizing the work data 160, or synthesizing related work data 160; and
one or more databases 330 for storing at least data including one or more of:
   device settings 332 including common device settings (e.g., service tier, device model, storage capacity, processing capabilities, communication capabilities, etc.) of the one or more servers 120, client devices, or smart devices;
   user account information 334 for the one or more user applications 324, e.g., usernames, security questions, account history data, user preferences, and predefined account settings;
   network parameters 336 for the one or more communication networks 150, e.g., IP address, subnet mask, default gateway, DNS server and host name;
   training data 338 for training one or more data processing models 340;
   data processing model(s) 340 for processing work data 160 (e.g., video, image, audio, or textual data) using deep learning techniques;
   work data 160 and associated results, where the work data 160 is processed using the data processing models 340 remotely at the server 120 or locally at the client device 240 to provide the associated results to be presented on the client devices or further processed.

In some implementations, the server-side module 206 acts as a control layer or API to the underlying functionality. In some implementations, the server-side module includes one or more of an emitter modulation module, a signal detection module, an object detection module, a location module, a movement module, a depth mapping module, and/or a gesture determination module for a smart device 280. Some implementations implement all of these features at a server system 120, some implementations implement all of these features at the camera 110, and some implementations distribute the functionality between the server 120 and the imaging device (e.g., based on efficiency considerations). In some implementations, the server-side module 206 includes a response processing module, which receives either raw unprocessed signals received at a camera 110 or signals that have been preprocessed by a local response processing module at the camera 110. The response processing module prepares the work data 160 (e.g., time of flight detection data) for use by the location module, the movement module, the depth mapping, and/or the gesture determination module. The server-side module 206 also includes an account administration module, which enables users to set up smart work environments 100 and to identify the smart devices 204 associated with the smart work environment 100.

In some embodiments, the data processing module 328 includes a data preparation module 350. More details on the data preparation module 350 are discussed below with respect to FIGS. 6A to 11.

Although many aspects of the present technology are described from the perspective of a computer system as a whole, the corresponding actions performed by the client device 240 and/or the server system 120 would be apparent to those of skill in the art. The server-side module 206 and the client-side module 202 are implemented at the server 120 and the client device 240, respectively. Each of the other modules 314-328 may be implemented in any of a server 120, a client device 240 (e.g., computer device 118, 130, or 134 in FIG. 1), a smart device 280 (e.g., devices 102-114 in FIG. 1), a storage 116, or a combination thereof.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules, or data structures, and thus various subsets of these modules may be combined or otherwise rearranged in various implementations. In some implementations, the memory 306 stores a subset of the modules and data structures identified above. In some implementations, the memory 306 stores additional modules and data structures not described above.

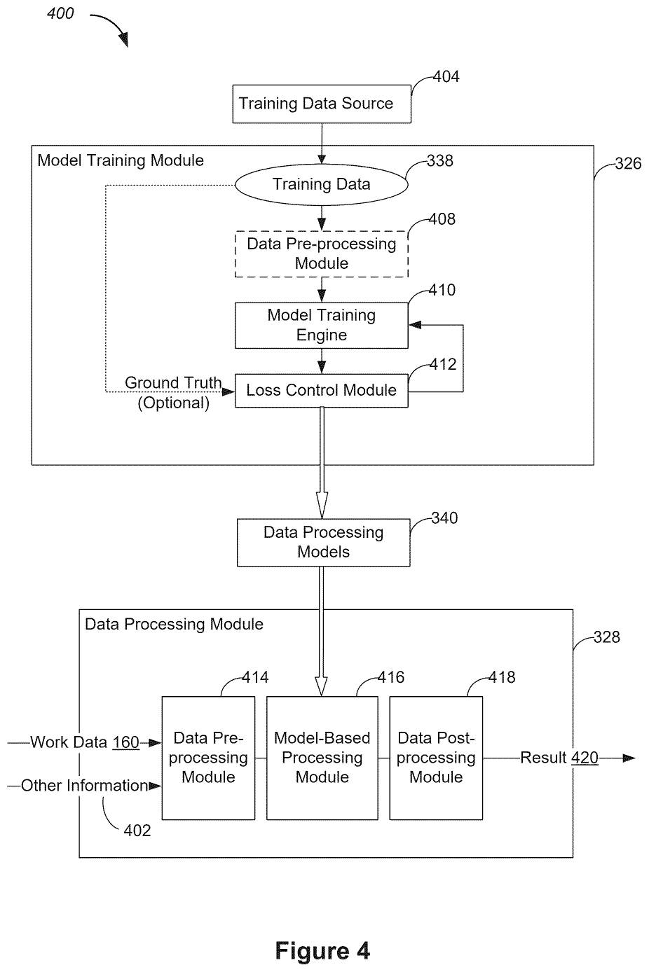

FIG. 4 is a block diagram of a machine learning system 400 for training and applying data processing models 340 using machine learning, in accordance with some embodiments. The machine learning system 400 includes a model training module 326 establishing one or more data processing models 340 and a data processing module 328 for processing data collected by smart devices 280 (e.g., cameras 110) using the data processing model 340. In some embodiments, both the model training module 326 (e.g., the model training module 326 in FIG. 3) and the data processing module 328 are located in the server 120, while a training data source 404 provides training data 338 to the server 120. In some embodiments, the training data source 404 is the data obtained from the smart devices 280, from another server 120, from storage 116, or from a client device. Alternatively, in some embodiments, the model training module 326 (e.g., the model training module 326 in FIG. 3) is located at a server 120, and the data processing module 328 is located in a smart device 280 or a client device 240. The server 120 trains the data processing models 328 and provides the trained models 340 to a smart device 280 or a client device 240 to process real-time work data 160 captured by the smart device 280.

In some embodiments, the training data 338 provided by the training data source 404 include a standard dataset (e.g., a set of work site images) widely used by engineers in an associated industry to train data processing models 340. In some embodiments, the training data 338 includes work data 160 and/or additional work site information, which is collected from one or more smart devices that will apply the data processing models 340 or collected from distinct smart devices that will not apply the data processing models 340. Further, in some embodiments, a subset of the training data 338 is modified to augment the training data 338. The subset of modified training data is used in place of or jointly with the subset of training data 338 to train the data processing models 340.

In some embodiments, the model training module 326 includes a model training engine 410, and a loss control module 412. Each data processing model 340 is trained by the model training engine 410 to process corresponding work data 160. Specifically, the model training engine 410 receives the training data 338 corresponding to a data processing model 340 to be trained, and processes the training data to build the data processing model 340. In some embodiments, during this process, the loss control module 412 monitors a loss function comparing the output associated with the respective training data item to a ground truth of the respective training data item. In these embodiments, the model training engine 410 modifies the data processing models 340 to reduce the loss, until the loss function satisfies a loss criteria (e.g., a comparison result of the loss function is minimized or reduced below a loss threshold). The data processing models 340 are thereby trained and provided to the data processing module 328 to process work data 160.

In some embodiments, the model training module 326 further includes a data pre-processing module 408 configured to pre-process the training data 338 before the training data 338 is used by the model training engine 410 to train a data processing model 340. For example, an image pre-processing module 408 is configured to format images in the training data 338 into a predefined image format. For example, the preprocessing module 408 may normalize the images to a fixed size, resolution, or contrast level. In another example, an image pre-processing module 408 extracts a region of interest (ROI) corresponding to a target area or object in each image or separates content of the target area or object into a distinct image.

In some embodiments, the model training module 326 uses supervised learning in which the training data 338 is labelled and includes a desired output for each training data item (also called the ground truth in some situations). In some embodiments, the desirable output is labelled manually by people or labelled automatically by the model training model 326 before training. In some embodiments, the model training module 326 uses unsupervised learning in which the training data 338 is not labelled. The model training module 326 is configured to identify previously undetected patterns in the training data 338 without pre-existing labels and with little or no human supervision. Additionally, in some embodiments, the model training module 326 uses partially supervised learning in which the training data is partially labelled.

In some embodiments, the data processing module 328 includes a data pre-processing module 414, a model-based processing module 416, and a data post-processing module 418. The data pre-processing modules 414 pre-processes work data 160 based on the type of the work data 160. In some embodiments, functions of the data pre-processing modules 414 are consistent with those of the pre-processing module 408, and convert the work data 160 into a predefined data format that is suitable for the inputs of the model-based processing module 416. The model-based processing module 416 applies the trained data processing model 340 provided by the model training module 326 to process the pre-processed work data 160. In some embodiments, the model-based processing module 416 also monitors an error indicator to determine whether the work data 160 has been properly processed in the data processing model 340. In some embodiments, the processed work data is further processed by the data post-processing module 418 to create a preferred format or to provide additional work information, associated with the smart work environment 100, which can be derived from the processed work data.

In some embodiments, work data 160 are supplemented with other information 402 (e.g., additional work site information, which is collected from one or more smart devices that will apply the data processing models 340 or collected from distinct smart devices that will not apply the data processing models 340). In some embodiments, the data processing module 328 uses the processed work data (e.g., result 420) to at least partially autonomously control an equipment or tool (e.g., forklift 126 in FIG. 1) that operates in the smart work environment 100. For example, the processed work data includes control instructions that are used by a control system (manned or unmanned) to drive the forklift 126. In some embodiments, the processed work data (e.g., result 420) is applied to at least partially autonomously control a robot operating on a vehicle assembly line or in an electronics manufacturing facility.

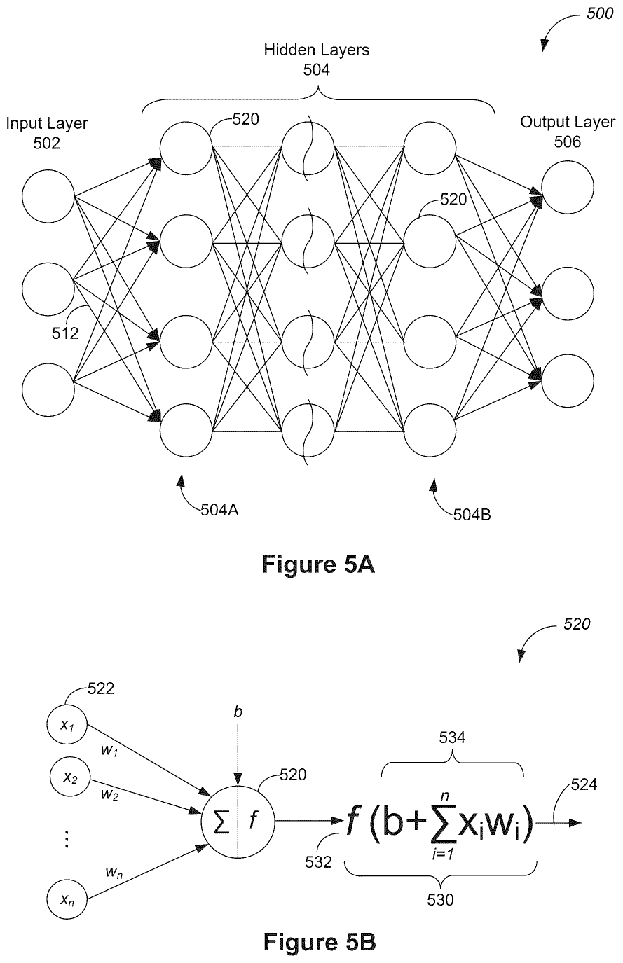

FIG. 5A is a structural diagram of an example neural network 500 applied to process work data in a data processing model 340, in accordance with some embodiments, and FIG. 5B is an example node 520 in the neural network 500, in accordance with some embodiments. It should be noted that this description is used as an example only, and other types or configurations may be used to implement the embodiments described herein. The data processing model 340 is established based on the neural network 500. A corresponding model-based processing module 416 applies the data processing model 340 including the neural network 500 to process work data 160 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w1, w2, w3, and w4 according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a data processing model 340 to process work data (e.g., video and image data captured by cameras 110). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the data processing model 340 to process work data 160. Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of work data are processed by the data processing module 328, and two or more types of neural networks (e.g., both a CNN and an RNN) are applied in the same data processing model 340 to process the work data jointly.

The training process is a process for calibrating all of the weights wᵢ for each layer of the neural network 500 using training data 338 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the linear weighted combination 534 from the previous layer before the activation function 532 is applied. The network bias b provides a perturbation that helps the neural network 500 avoid over fitting the training data. In some embodiments, the result of the training includes a network bias parameter b for each layer.

FIG. 6A illustrates a workflow 600 for preparing data, in accordance with some embodiments. In some embodiments, the workflow 600 implemented by the data preparation module 350 that is described with respect to FIG. 3. In some embodiments, the data preparation module 350 is an AI system that includes one or more AI models. In some embodiments, the workflow 600 is an AI pipeline implemented by one or more AI models. In some embodiments, the steps in the workflow 600 are executed automatically by a computer system (E.g., computer system 300) without user input or user intervention.

In some embodiments, the workflow 600 includes obtaining initial data 602 from sensors that are installed in physical environment(s), such as manufacturing, hospital, or retail environments. In some embodiments, the sensors can include one or more of: a camera, a temperature sensor, a humidity sensor, an airflow sensor, a pressure sensor, a vibration sensor, a gas sensor, a presence sensor, a moisture sensor, a light sensor, a radar sensor, a LiDAR sensor, and a motion sensor. In some embodiments, the physical environment can include hospitals, manufacturing facilities, warehouse facilities, or smart cities. The example of FIG. 6A is based on a scenario where imaging data collected by a camera. The components in the top row of FIG. 6A illustrate the data pipeline whereas those at the bottom row illustrates data (e.g., images) that are being transferred and/or transformed in each step of the processing pipeline. It should be apparent to one of ordinary skill in the art that the processes in the AI pipeline illustrated in FIG. 6A are equally applicable to data with other modalities such as text, audio, or time series data.

In some embodiments, the workflow includes a data reduction process 604 (e.g., data downsampling) where the data preparation module 350 identifies and removes redundant information from the data. In some embodiments, the data reduction process 604 reduces the dataset to be processed by the AI pipeline by removing redundant data that does not provide value-added information.

In some embodiments, the data preparation module 350 identifies “near redundant” data, such as images with similar features but varying imaging conditions such as varying brightness and contrast. For example, in some embodiments, the data preparation module 350 determines that there are multiple image whose brightness and/or contrast are substantially similar, and selects a subset of (i.e., less than all) the image frames while removing the rest of the image frames. In some embodiments, “near redundant” data comprises successive images depicting an object that has not moved significantly in consecutive images. For example, the data preparation module 350 may determine a set of image frames in which a movement of an object in the set of image frames is within a tolerance, and selects a subset (i.e., less than all) of the image frames for further processing while discarding the remaining image frames.

In some embodiments, to identify redundancies in image data, the data preparation module 350 implements histogram-based image comparison 606 (e.g., pixel value distribution). In some embodiments, the data preparation module 350 is configured to apply feature-based matching 608 (e.g., feature detection and matching) to identify redundancies in image data. An image feature includes information that describes the objects with a unique quality. Example image features can include anything from simple edges and corners to more complex textures like intensity gradients or unique shapes like blobs. In some embodiments, image features can include local features or global features. Local features are specific parts of an image that capture information about small regions, whereas global features describe the entire image as a whole and capture overall properties such as shape, color histogram, and texture layout. In some embodiments, the data preparation module 350 applies feature detection algorithms such as the Scale Invariant Feature Transform (SIFT) algorithm and speeded-up robust features (SURF) algorithm. SIFT detects, describes, and matches local features in images. In some embodiments, SIFT calculates a similarity score that defines the extent to which the images are similar. SURF determines local, similarity invariant representations and compares images. Interest points of a given image are defined as salient features from a scale-invariant representation. Using these algorithms, duplicative or similar images can be determined and removed (e.g., de-duplicated) from the initial data.

In some embodiments, the data preparation module 350 is configured to apply block-based matching 610 to determine similarities between different features in an image by comparing and sorting blocks based on various techniques such as sorting, hash functions, correlation, and distance measurements. For example, the data preparation module 350 can apply perceptual hashing to determine images (or videos) that are very similar or apply cryptographic hashing to identify exact matches between different images or video frames and remove those images or video frames that are duplicative or similar. In some embodiments, the data preparation module 350 is configured to apply deep learning-based techniques to determine similarities between different images or video frames. For example, convolutional neural networks (CNNs) or recurrent neural networks (RNNs) are trained and applied to analyze images, spatial data, and/or temporal data to identify similarities between previously obtained features for removal from the initial data.

For numerical or time-series data, the data preparation module 350 is configured to apply correlation-based (614), Euclidean distance (616), Fourier transform (618), and frequency domain-based (620) algorithms to identify and remove duplicative or similar data, in accordance with some embodiments. An example correlation-based algorithm is cosine similarity, which measures the similarity between two pieces of data by calculating the cosine of the angle between two vectors representing the data. An example correlation-based algorithm is Jaccard similarity, which is a proximity measurement that compares two sets, such as two documents, and outputs an index ranging from 0 to 1.

Following the application of the algorithms in the data reduction step 604, redundant data will be removed or flagged, thus reducing the initial data toa set of reduced data 621 having a smaller data size compared to the initial data 602. In some embodiments, the remaining data contains unique data.

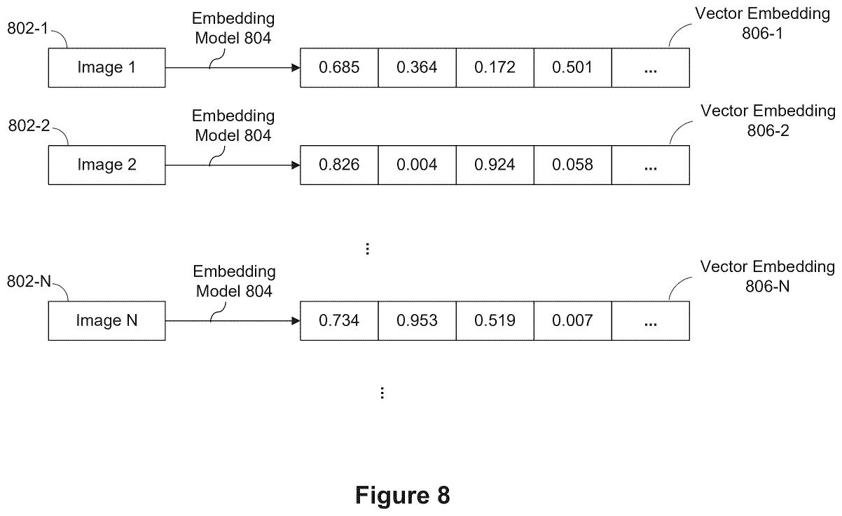

In some embodiments, the reduced data 621 are used as inputs for the embedding extraction process 622 to extract (e.g., generate) embeddings 631. Embeddings 631 comprise signature-like representations to describe the original data (e.g., images, text, audio). Because embeddings have a smaller file size compared the original data, the data size is further reduced in this process. In some embodiments, embeddings 631 are encoded representations of data that machines can interpret and that capture temporal, spatial, and contextual information depending on the application. Referring to FIG. 8, in some embodiments, the data preparation module 350 applies an embedding model 804 (e.g., data processing models 340) that generates vector embeddings 806 (e.g., vector embedding 806-1, 806-2 and 803-N) from images 802 (e.g., image 802-1, 802-e, and 802-N). The vector embeddings 806 make it possible to translate semantic similarity or contextual similarity to proximity in a vector space.

In some embodiments, in the embedding extraction process 622, the data preparation module 350 extracts context from the data. In some embodiments, for image data, the data preparation module is configured to apply deep neural networks such as CNNs, transformer-based models (e.g., openCLIP or CLIP-ViT), large vision models (LVMs), or auto-encoders to extract embeddings, features, low-level details (e.g., brightness and color) or high-level details (e.g., aesthetics) from the images. For time-series data, the data preparation module is configured to extract meaningful representations of the data (e.g., data plots, graphs, curves, data trends) such as statistical, temporal, or frequency-based patterns, and create low-dimensional vectors that preserve temporal dependencies.

In some embodiments, the data preparation module 350 uses the embeddings 631 as inputs to the data clustering process 632 and outputs data clusters 641 (e.g., image clusters, text clusters). In some embodiments, the data preparation module 350 uses information in the embeddings 631 to create clusters using state-of-the-art clustering algorithms such as k nearest neighbors (634) (e.g., k-means), density-based spatial clustering of applications with noise (DBSCAN), Gaussian mixture models (GMM) clustering or hierarchical clustering. Because most clustering algorithms require a “number of clusters” as an input, in some embodiments, the data preparation module 350 determines the optimal number of clusters using techniques such as the elbow method and silhouette coefficients to determine an optimal number of clusters in the dataset. In some embodiments, the data preparation module 350 executes the algorithms iteratively until the optimal number of clusters are converged. For example, k-means clustering is a centroid based technique that organizes the data with respect to a centroid position. In some embodiments, the data preparation module 350 is configured to apply metrics (e.g., clustering KPIs) such as silhouette scores, the Davies-Bouldin Index, and the Calinski-Harabasz Index, to evaluate how well a clustering algorithm groups data points into clusters. The silhouette score evaluates how well a clustering algorithm groups data points into clusters. A high score indicates that the clusters are well-separated and cohesive, while a low score indicates poor clustering. The Davies-Bouldin Index evaluates clustering effectiveness by measuring the compactness and separation of clusters. It calculates a ratio that compares the average distance between clusters with the average distance within each cluster. The Calinski-Harabasz Index (CHI), also known as the Variance Ratio Criterion (VRC), is a metric for evaluating clustering algorithms. The data preparation module 350 will select the clustering algorithm that reaches the highest clustering KPI yield and produce organized clusters of data.

With continued reference to FIG. 6A, in some embodiments, the data clusters 641 are used as inputs in a keyword extraction process 642 to generate metadata 647 for the data clusters. The keyword extraction process 642 attaches semantics (e.g., human language, keywords, or meaning) to the data clusters by providing some information about the clusters. In some embodiments, the data preparation module 350 applies a multimodal literate model such as Kosmos 644 for machine reading of text-intensive images or an image captioning model based on the Bootstrapping Language-Image Pre-training (BLIP) 646 framework in the keyword extraction process 642.

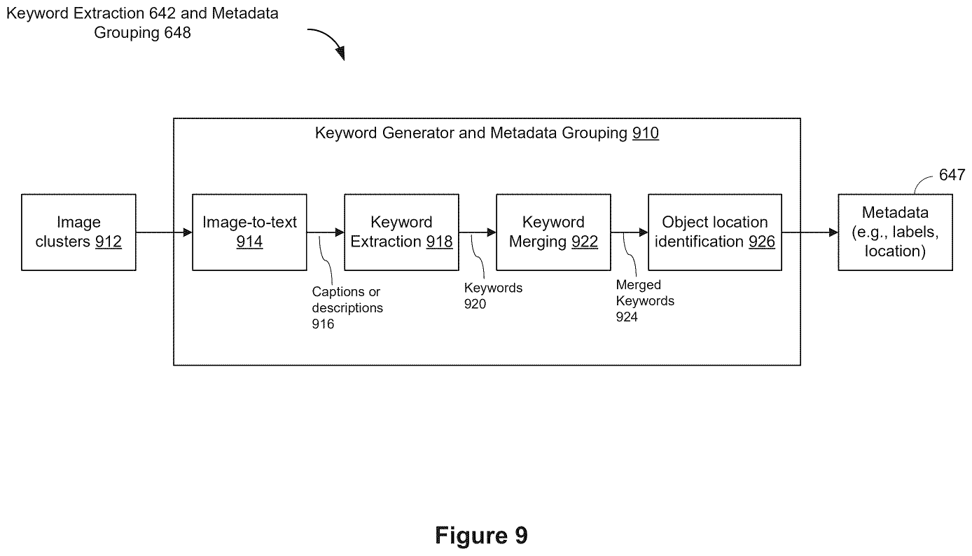

In some embodiments, in the case of image clusters, the keyword extraction process 642 and the metadata grouping process 648 are multi-step processes that are implemented using a keyword generator and metadata grouping component 910 that is illustrated in FIG. 9, in accordance with some embodiments. In FIG. 9, the keyword generator and metadata grouping component 910 receives image clusters 912 (e.g., data clusters 641) and applies image-to-text processing 914 to generate captions or descriptions 916 (e.g., image captions or image descriptions) for the image clusters 912. Examples of image-to-text processing 914 include deep learning-based methods for image caption, which uses CNNs to extract visual information from images, followed by RNNs (e.g., long short-term memory (LSTM)). Other image-to-text techniques can include transformer-or mamba-based Generative AI methods to generate grammatically and contextually accurate captions or description. With continued reference to FIG. 9, in the keyword extraction step 918 (e.g., corresponding to keyword extraction 642), the captions or descriptions 916 are input into a keyword extractor (e.g., data processing models 340). The keyword extractor processes the captions or descriptions 916 to automatically extract the relevant keywords 920 (e.g., descriptions or metadata) from them. A keyword can be a single word such as “bottle,” two or more words such as “glass container” or “blue plastic bottle,” a phrase such as “soda bottle on conveyor belt,”, or a concatenation of keywords such as {“automobile”; “car” and “sideview mirror”}. In some embodiments, keyword extraction is performed on a per-image basis. In some embodiments, keyword extraction is performed on a per image cluster basis, which further reduces the amount of computation performed by the AI processing pipeline. In some embodiments, for clustering based keyword extraction, the data preparation module 350 can identify a subset of images within a respective cluster that are very similar and passes on a representative image of the subset to the keyword generator and metadata grouping component 910 so that the keyword extraction is performed only on the representative images, thus saving on computational time and cost.

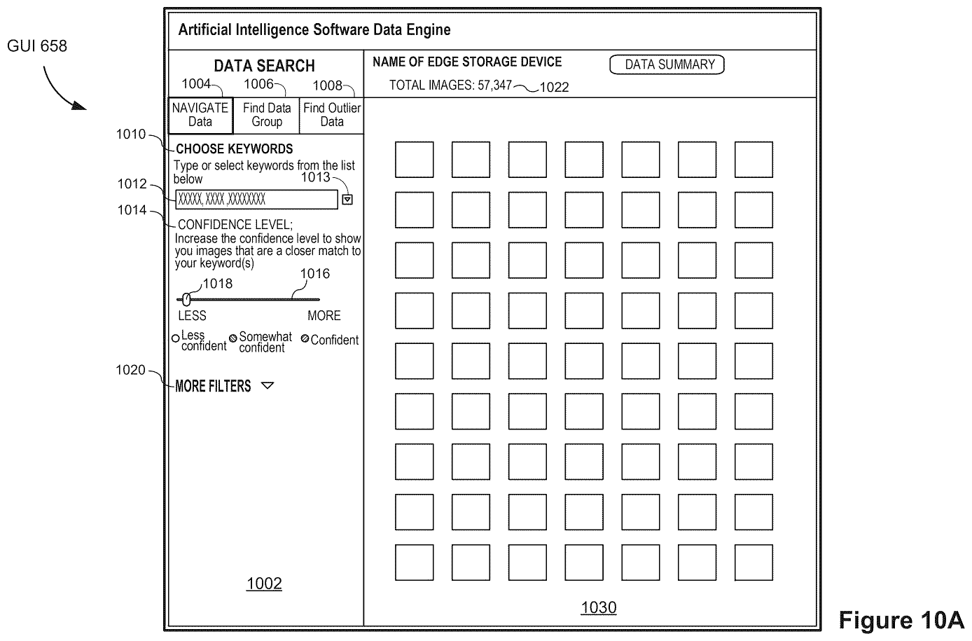

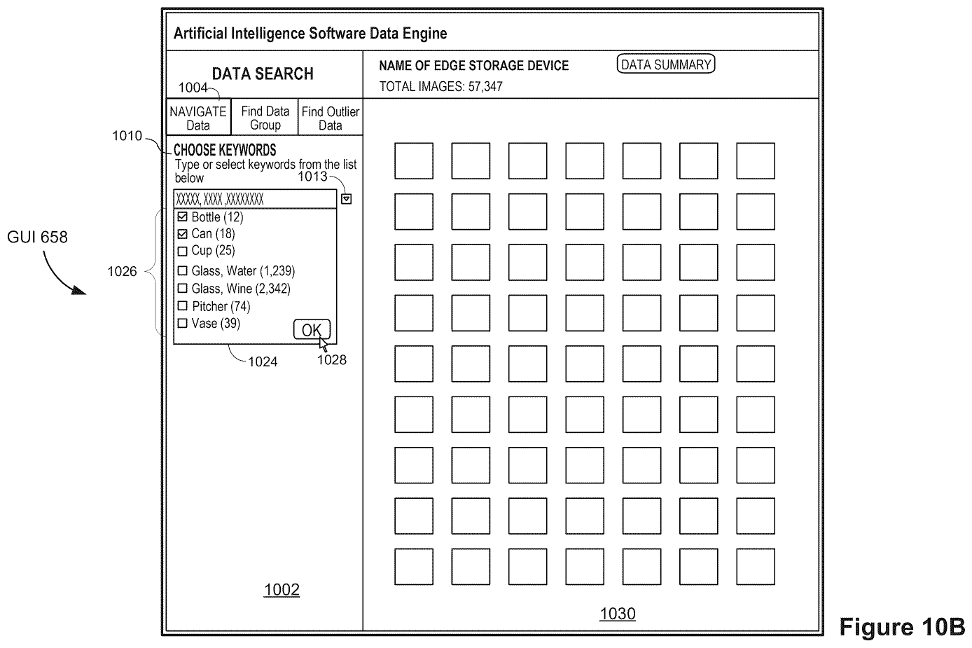

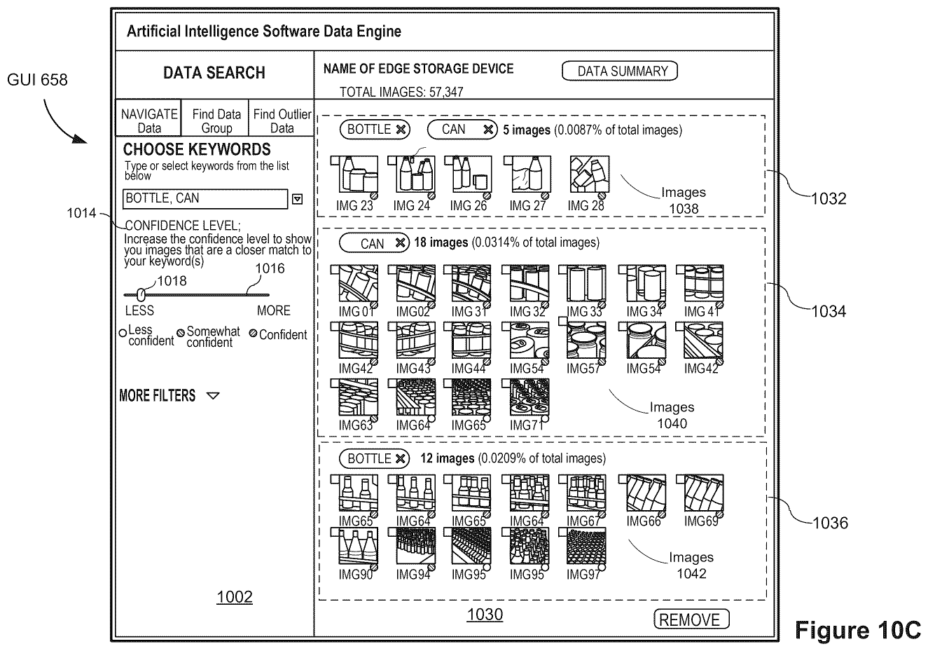

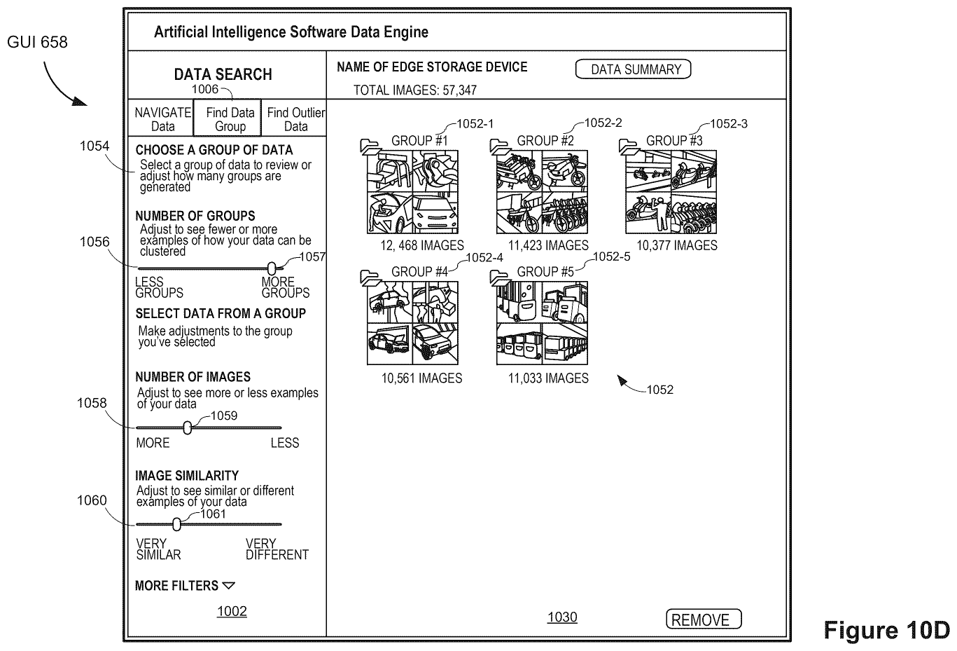

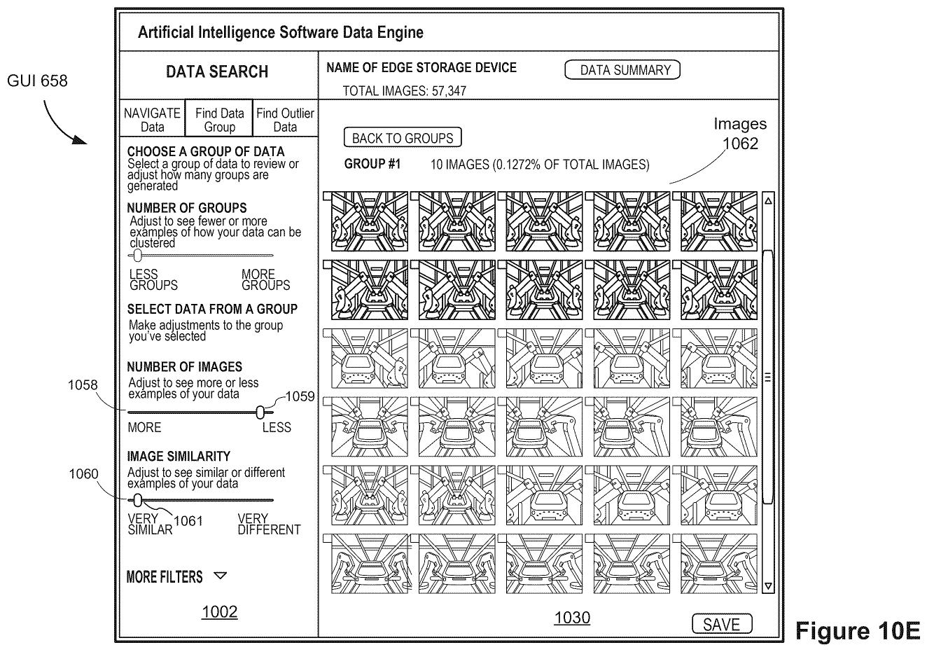

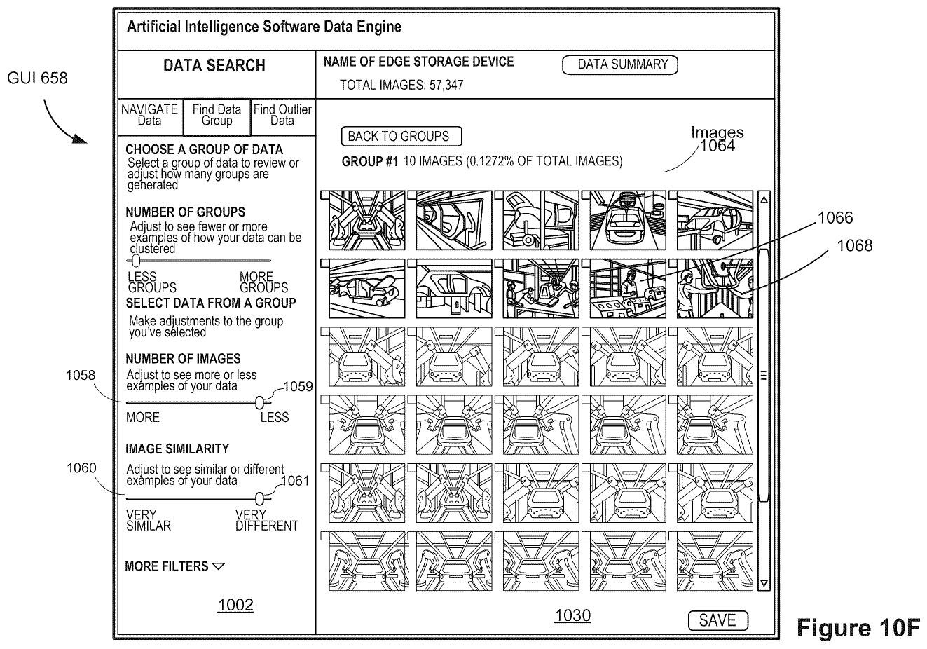

In some embodiments, the keyword extractor employs various natural language processing-based methods, such as spaCy, YAKE, and RAKE, to extract the keywords 920. In some embodiments, the keyword extractor can extract keywords (e.g., metadata) that are similar. In some embodiments, the keyword extraction step 918 is followed by a keyword merging step 922 where metadata (e.g., keywords) are grouped by merging similar keywords based on their semantics and contextual information (e.g., relationships with each other) to generated merged keywords 924. For example, keywords “arrow” and “arrows” can be identified as belonging to the same context and grouped (e.g., merged) under a common keyword “arrow.” In the object location identification step 926, the keyword generator and metadata grouping component 910 detects the location of the keywords (e.g., merged keywords 924) in each image. using object detection or object segmentation models such as yolo, SSD, retinaNet, Vision transformer, or segment anything model (SAM). At the end of step 926, each image in the image clusters will have the associated metadata 647 (e.g., keywords with their relevant location in the image). In some embodiments, the metadata 647 are descriptors (e.g., language descriptors) of existing events or objects in the data clusters (e.g., images). In some embodiments, the metadata 647 includes a confidence level indicating a level of confidence that a respective keyword is associated with a respective image (e.g., relevance of the keyword to the image). In some embodiments, during subsequent data exploration, the confidence level metadata is used to filter the images using a confidence level slider tool, as discussed with reference to FIGS. 10A to 10F. In some embodiments, the metadata 647 includes keyword ranking information. For example, in some embodiments, the data preparation module 350 may rank the keywords according to one or more ranking criteria such as frequencies of occurrences of a respective keyword, search volume, correlation between a respective keyword and an image cluster size, and correlation between a respective keyword and locations of images matching the respective keyword in the image cluster (e.g., whether the respective keyword corresponds to images located closer or further away from the centroid of an image cluster).

With continued reference to FIG. 6A, the workflow 600 includes a metadata grouping process 648 that takes the metadata 647 (e.g., keywords) as inputs and generates metadata groupings 653, such that the most relatable keywords are grouped together. Stated another way, the metadata grouping process clusters the metadata 647 (e.g., keywords), which reduces the number of keywords for a respective data cluster. For example, the keywords “van” and “sedan” may be different words, but contextually they might be related to a certain category of keyword or a label such as “automobile,” and may be grouped together in the metadata grouping process 648.

For example, in some embodiments, the data preparation module 350 applies a sentence transformer model (e.g., SBERT 650) or a natural language processing model such as MiniLM 652 to map the metadata to a vector space and group subsets of metadata together based on their similarity. In some embodiments, the data preparation module 350 labels a respective data cluster with metadata 647 or metadata groups 653.

In some embodiments, the workflow 600 includes a contextual image navigation process 654. In some embodiments, the data preparation module 350 is configured to execute an image management application 656 that includes a graphical user interface (GUI) 658 for enabling navigation and exploration of data clusters (e.g., clusters of images), keywords, metadata and annotations that were generated as described herein.

In the example of FIG. 6A, the AI pipeline operates in a sequential way where the steps of data reduction, embedding extraction, image clustering, and keyword extraction are performed sequentially. In some embodiments, some of these processes can occur in parallel. This is illustrated in FIG. 6B.

FIG. 6B illustrates a workflow 670 for preparing data, in accordance with some embodiments. FIG. 6B shows that, in some embodiments, after the data reduction step 604, embeddings 672 are extracted from the reduced data 621 via embedding extraction 622. The embeddings 672 are processed in the keyword extraction step 642 to generate embedding keywords 674, which are subjected to metadata grouping 648 to generate metadata groups 676. FIG. 6B also shows that, in some embodiments, after the data reduction step 604, data clustering 632 is performed on the reduced data 621 to generate data clusters 678. Cluster keywords 680 are extracted from the data clusters 678 via keyword extraction 642. The cluster keywords 680 are then grouped via metadata grouping 648 to generate metadata groups 682. FIG. 6B also shows that, in some embodiments, after the data reduction step 604, keyword extraction 642 is performed on the reduced data 621 to obtain keywords 682. The keywords 682 are then grouped via data clustering 632 to obtain cluster keywords 684. The cluster keywords 684 are then grouped via metadata grouping 648 to generate metadata groups 686.

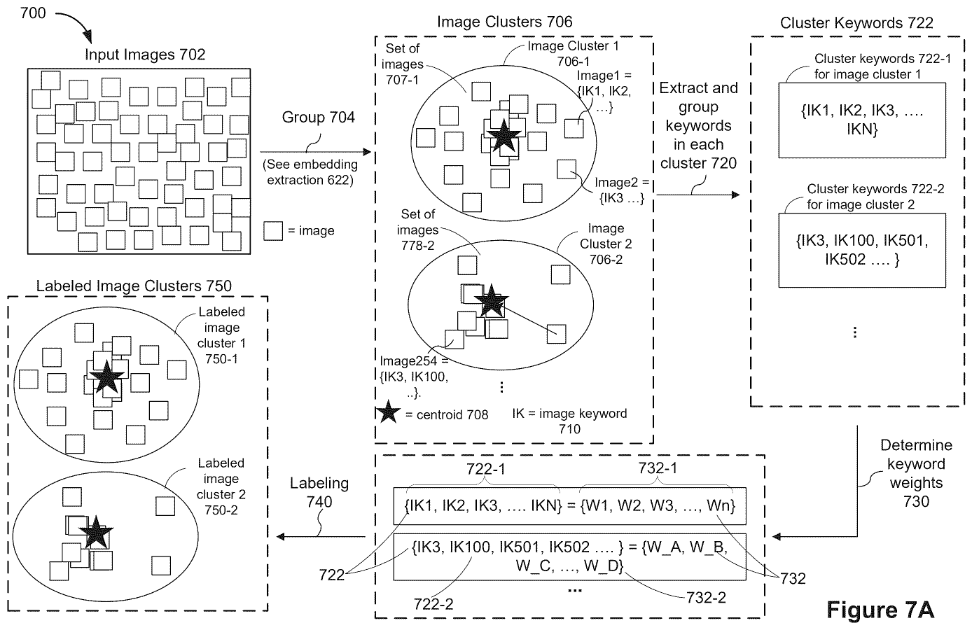

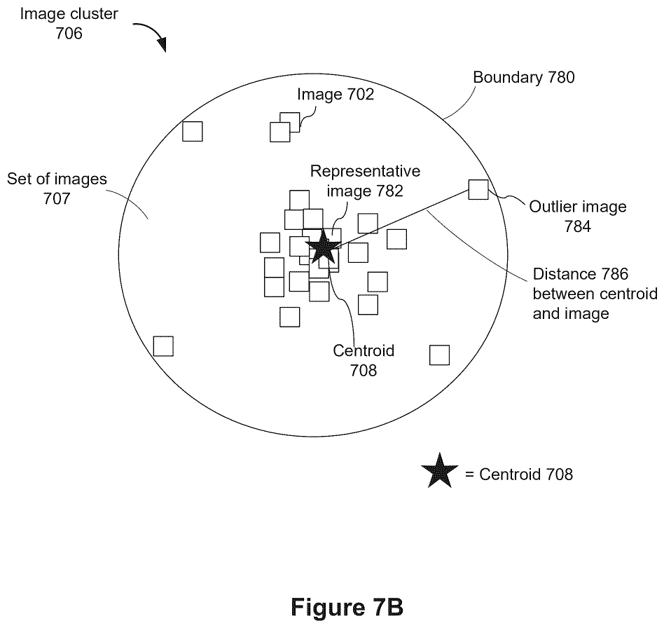

FIG. 7A illustrates an image clustering workflow 700 for generating and labeling clusters of images, in accordance with some embodiments. As noted above, the data clusters 641 can be image clusters. An image cluster is also known as a cluster of images. The workflow 700 begins with the data preparation module 350 receiving input images 702. Note that the input images 702 can correspond to either initial data 602 or reduced data 621 in FIG. 6A. In some embodiments, the input images 702 can comprise 100,000, 500,000, 1 million, or millions of images. The input images are grouped (step 704) into different image clusters 706 (e.g., image cluster 706-1 and image cluster 706-2). In some embodiments, a respective image cluster 706 can include at least 10,000 images, 50,000 images, or 100,000 images. In some embodiments, the grouping is according to image embeddings (e.g., embeddings 631) of the input images 702. FIGS. 7A and 7B show that a respective image cluster 706 has a boundary 780 that defines a respective set of images 707 included in that cluster. A respective image cluster has one or more representative images 782 that represent the characteristics of the set of images 707 included in the cluster. In some embodiments where centroid-based clustering algorithms (e.g., k-means) are applied to derive the image clusters, the image cluster 706 includes a centroid 708 representing the arithmetic mean position of all the images in the cluster. A distance (786) between a respective image 702 and the centroid 708 (or the most representative image 782) represents an image similarity between different images in the cluster. FIG. 7B shows an outlier image 784 where the distance between the outlier image 784 and the centroid 708 is larger compared to other respective distances between respective images 702 in the cluster and the centroid 708. In some instances, some of the input images 702 may not form image clusters (e.g., because some of the input images do not meet the clustering metrics described in the clustering process 632). In circumstances like these, the computer system 300 may group these input images into a bucket of “miscellaneous” and generate keywords for them, in accordance with some embodiments.

With continued reference to FIG. 7A, in some embodiments, each image in the set of images has one or more image keywords 710 (denoted as “IK” in FIG. 7A). In step 720, the data preparation module 350 extracts the image keywords 710 from each image of the cluster and groups (e.g., concatenates) the keywords to form cluster keywords 722 (e.g., 722-1 and 722-2). The image clustering workflow 700 continues at step 730, where the data preparation module 350 determines sets of keyword weights 732 (e.g., 732-1 and 732-2) that each corresponds to one respective set of cluster keywords 722. A respective keyword weight (KWᵢ) (e.g., W1, W2, W_A or W_B in FIG. 7B) is associated with a respective one cluster keyword in the set of cluster keywords 722 based on cluster locations images in the cluster. In some embodiments, a cluster keyword is a keyword that is associated with a respective cluster of images (e.g., image cluster). As one example, in some embodiments, keywords extracted from images that are located closer to the centroid 708 are assigned higher weights compared to keywords extracted from images that are located further away from the centroid 708. The rationale for this is that the keywords corresponding to images located near the centroid are likely those with the highest confidence and the most prevalent. As another example, in some embodiments, an image cluster that contains a larger number of images is assigned a higher weight compared to another image cluster that contains a smaller number of images (e.g., the weight is proportional to the size of the cluster).

In some embodiments, the workflow 700 includes a labeling step 740 where a respective image cluster 706 is labeled with its corresponding set of cluster keywords 722 and its corresponding set of keyword weights 732 (e.g., 732-1 and 732-2) to form labeled image clusters 750.

Although the workflow 700 in FIG. 7A shows that the image keywords 710 are extracted from respective images of an image cluster and grouped to form cluster keywords 722, it would be apparent to one of ordinary skill in the art that the ordering of the steps illustrated in FIG. 7A are merely exemplary and can be interchangeable. For example, in some embodiments, keywords are extracted from each of the input images 702 prior to the input images being grouped into image clusters 706. In some embodiments, the input images 702 are grouped to form image clusters 706 and the keyword extraction occurs after the image clusters 706 have been formed.

FIGS. 10A to 10F illustrate a graphical user interface (GUI) 658 for navigating clusters of images, keywords, and metadata, in accordance with some embodiments.

FIG. 10A shows that the GUI 658 includes a data search panel 1002 and an image display panel 1030. The data search panel 1002 includes a tab 1004 for navigating data, a tab 1006 for finding groups of similar data, and a tab 1008 for finding outlier data. The tab 1004 includes an affordance 1010 for selecting keywords (e.g., by typing into a search bar 1012 or selecting arrow key 1013 to display a dropdown menu), and option 1014 for specifying a confidence level for a match between the selected keywords and the images that are displayed. The option 1014 includes a user-adjustable confidence level slider 016 with an indicator 1018 (e.g., user interface element) for allowing a user to select a value or range of values. For example, positioning the indicator 1018 toward the left (i.e., less confident) causes the GUI 658 to present images that are less of a close match to the selected keywords, whereas positioning the indicator 1018 toward the right (i.e., more confident) causes the GUI 658 to present images that are a closer match to the selected keywords. The “confidence level” metadata of each keyword associated with the image are used to filter the images by using the confidence level slider 1016. The tab 1004 also includes filter options 1020. FIG. 10A also shows the GUI 658 displaying an indicator 1022 indicating the total number of images (e.g., reduced data 621) in the dataset.

FIG. 10B illustrates a user interaction with the GUI 658. In this example, user selection of the arrow key 1013 causes display of a dropdown menu 1024 with keywords 1026. In some embodiments, the keywords 1026 are keywords that are auto-populated. The number next to each of the keywords indicates the number of images associated with the respective keywords. The user can select or de-select the keywords from the list or type into the search bar 1012 to search for other keywords. In this example, the user selects the keywords “Bottle” and “Can” and clicks the “OK” button 1028.

FIG. 10C shows that in response to the user interaction, the GUI displays, in the display panel 1030, all the images that correspond to the keywords “bottle” and “cap” Specifically, in FIG. 10C, the top area 1032 of the display panel 1030 displays the image representations 1038 of all images that have both the keywords “bottle” and “can”, the middle area 1034 of the display panel 1030 displays the image representations 1040 of all images that only have the keyword “can”, and the bottom area 1036 of the display panel 1030 displays the image representations 1042 of all the images that only have the keyword “bottle.” The confidence level indicator 1018 indicates a level of confidence (e.g., of the AI processing pipeline) that the displayed images contain one or more of those keywords.

FIGS. 10D to 10F illustrate options for exploring groups of similar data (e.g., tab 1006) in accordance with some embodiments.

In FIG. 10D, the tab 1006 (“Find Groups of Similar Data”) is selected as the active tab. The display panel 1030 displays image groupings 1052 (e.g., image clusters 706 or data clusters 641) associated with the dataset, and a respective number of images in a respective image grouping. The data search panel 1002 displays guidance 1054 for a user to select a group of data (e.g., one or more image groupings 1052) to review and adjust. The data search panel 1002 displays a “number of groups” slider tool 1056 that enables a user to view fewer or more examples of how data can be clustered by adjusting the position of indicator 1057 on the slider tool 1056. The data search panel 1002 displays a “number of images” slider tool 1058 that enables a user to see fewer or more examples of images in a respective group (e.g., image cluster) by adjusting the position of indicator 1059 on the slider tool 1058. The data search panel 1002 also displays an “image similarity” slider tool 1060 that enables a user to see similar or different examples of images within an image cluster by adjusting the position of indicator 1061 on the slider tool 1060. For example, when the position of indicator 1061 is at or near the “very similar” end of the slider tool 1060, the GUI 658 will display images that are located near the centroid of the image cluster. When the position of indicator 1061 is at or near the “very different” end of the slider tool 1060, the GUI 658 will display images that are located further away from the centroid of the image cluster (e.g., outlier images). In FIG. 10D, the user selects image grouping 1 1052-1.

FIG. 10E illustrates that, in response to the user selection, the display panel 1030 displays a subset of images 1062 belonging to the selected group. In FIG. 10E, the user specifies, by adjusting the positions of the indicators 1059 and 1061 corresponding to the respective slider tools 1058 and 1060, that the user would like to see fewer images and very similar images (i.e., images that are most representative of the image cluster/at or near the centroid of the image cluster). In accordance with the user specification, the subset of images 1062 that are displayed are similar-looking images that each shows a car and robotic arms.

FIG. 10F illustrates a scenario where the user specifies, by adjusting the positions of the indicators 1059 and 1061 corresponding to the respective slider tools 1058 and 1060, that the user would like to see fewer images and very different images (i.e., images that are least representative of the image cluster/away from the centroid of the image cluster/outlier images). In accordance with the user specification, the subset of images 1064 that are displayed in the display panel 1030 are not all similar looking. For example, the subset of images 1064 include image 1066 and image 1068 depicting workers working on a production line, without a car and without robotic arms. In some embodiments, a user can select and save one or more of the images for further actions such as to generate training datasets, train AI models, detect events, identify objects, generate data summaries, flag unexpected results, or identify image outliers. In some embodiments, the user has the option of whether to further retain the data of choice and reduce the less valuable data.

The GUI 658 shown in FIGS. 10A to 10F illustrate exemplary ways in which a user can explore, filter, and select image clusters, keywords, and metadata. In some embodiments, the data management application 656 can be used by a system to filter data. For example, a system can manage a drive where data is stored and retains the most relevant (e.g., non-redundant) data by archiving all images that have no associated context/keyword. A user can then navigate a much smaller number of images to review the activity in the environment. This data can also be used to feed other processes such as business intelligence over multiple days/weeks, or even across multiple locations. In some embodiments, this data with its metadata (e.g., labels and segmentation) can then be used to feed an AI training model. Thus, the disclosed implementations automatically generate self-organized and self labelled data, and also significantly reduces the size of an initial dataset. The generated data clusters can be presented to the user in a more comprehensive manner and allows the user to use the data in different usage scenarios depending on their needs.

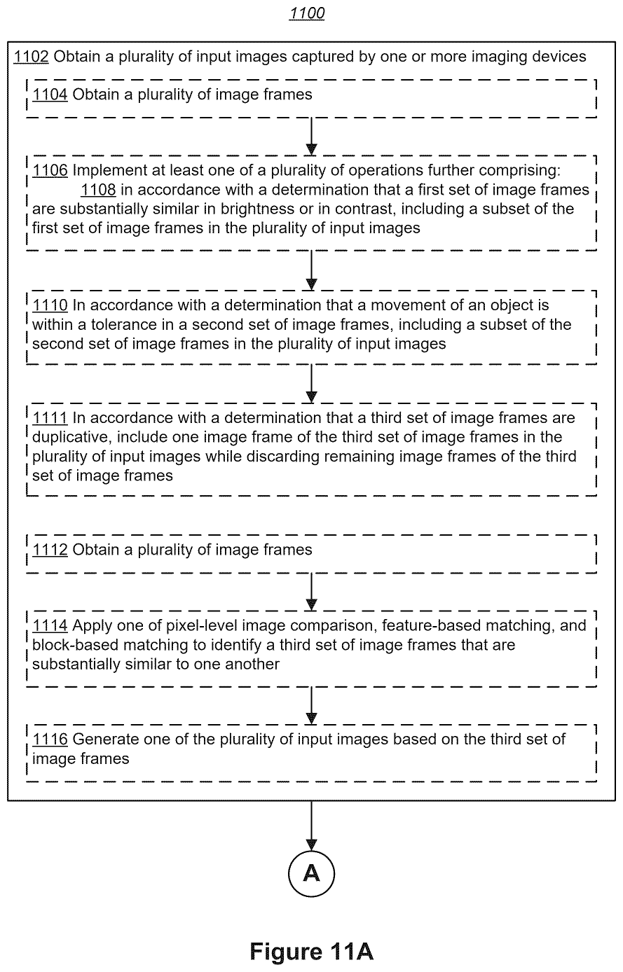

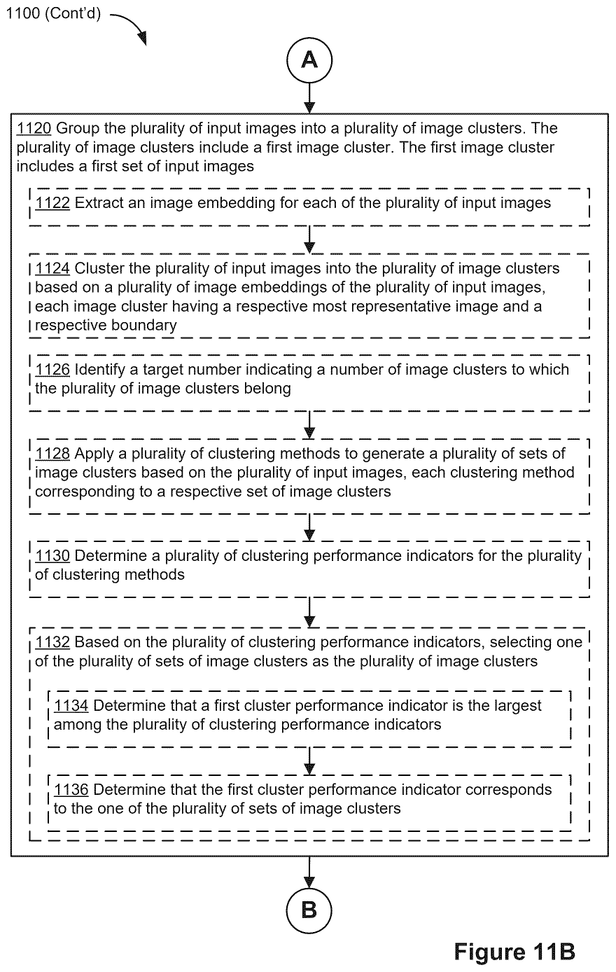

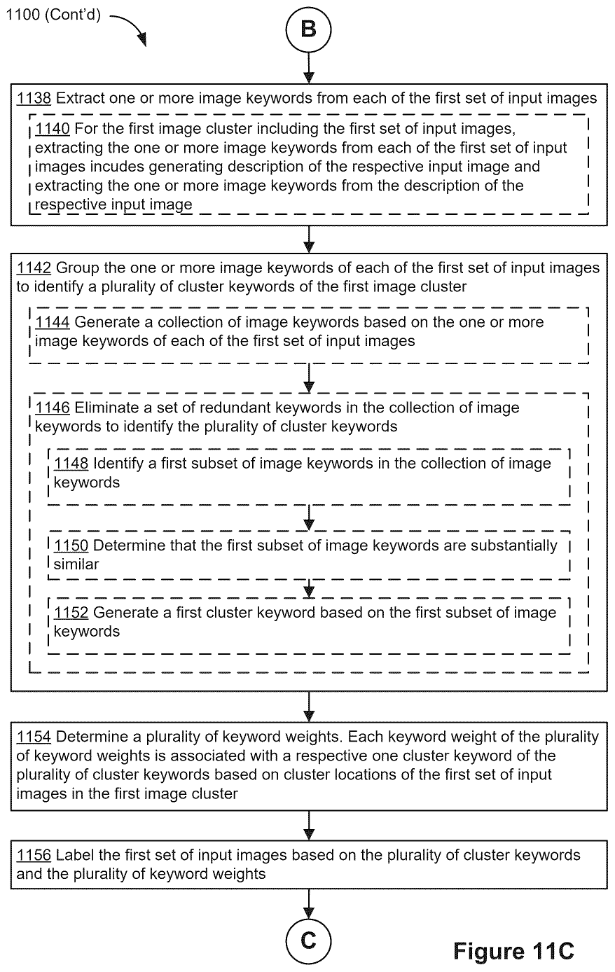

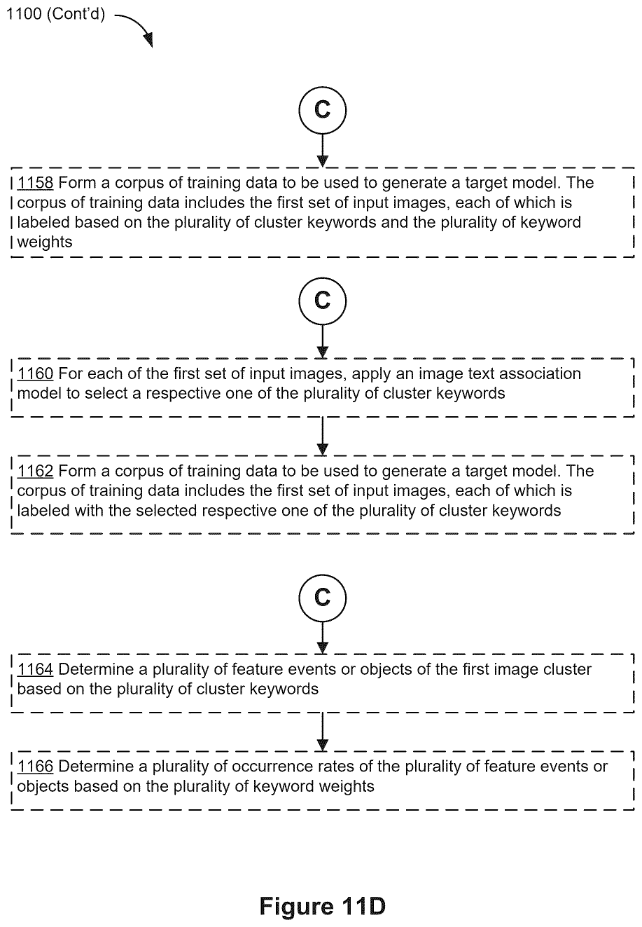

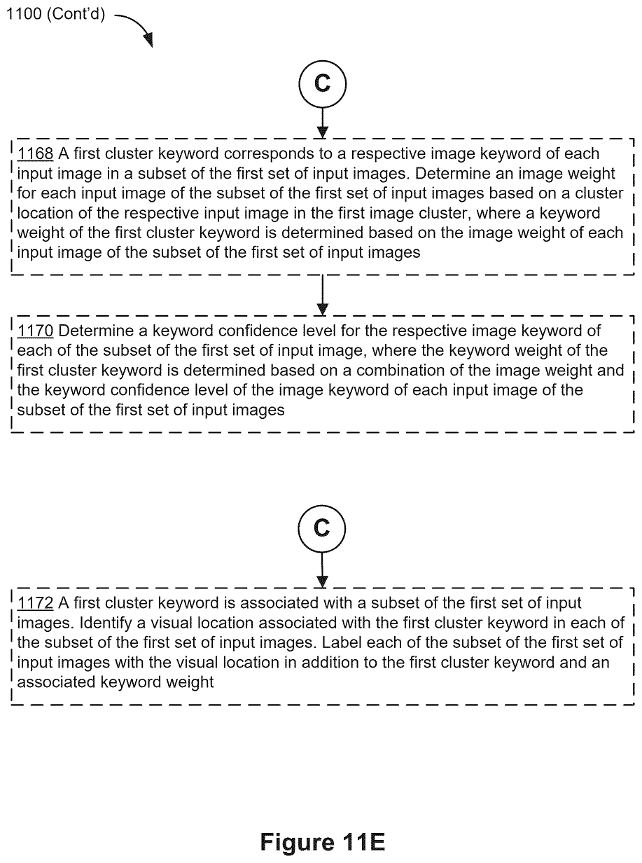

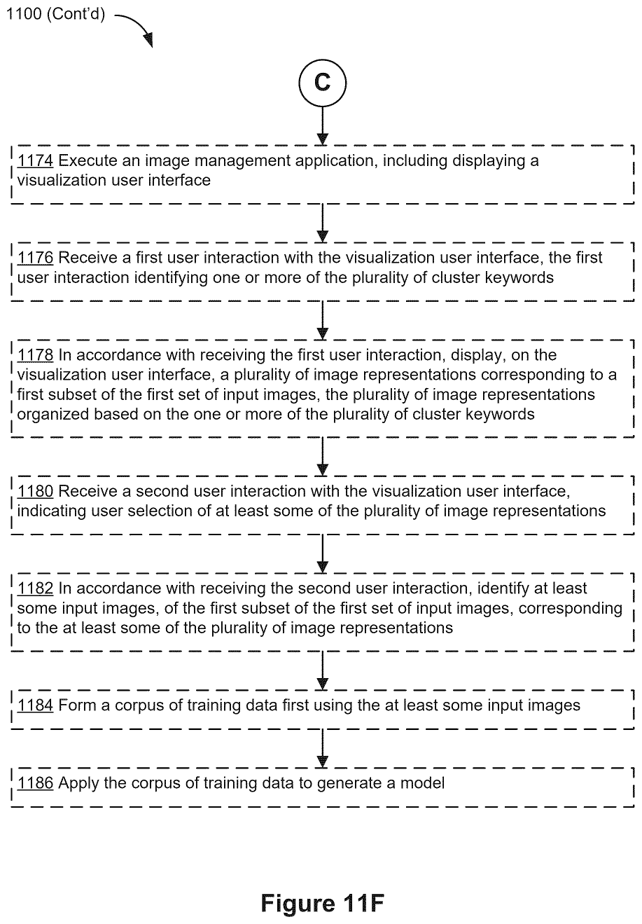

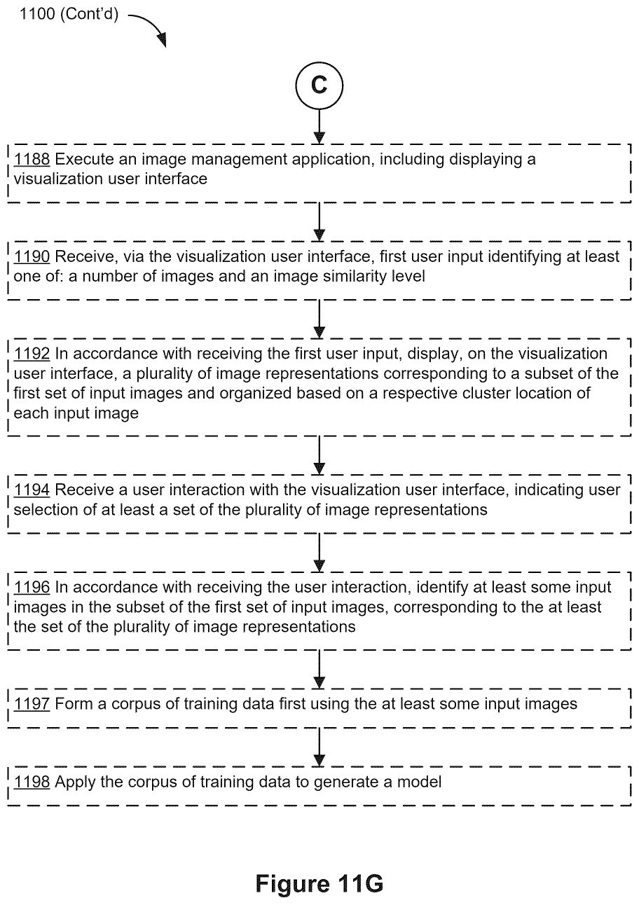

FIGS. 11A to 11G provide a flowchart of an example method 1100 for preparing data, in accordance with some embodiments. The method 1100 is performed at a computer system (e.g., computer system 300). In some embodiments, unless explicitly stated, the operations in the method 1100 are performed automatically by the computer system without requiring input or intervention by a user. In some embodiments, data preparation includes automatically organizing and/or labeling data by the computer system. In some embodiments, the automatic data organizing and/or labeling can be applied to the data that are obtained in the same session (e.g., around the same time) or from different sessions (e.g., at different times). In some embodiments, the computer system implements the automatic data organizing and/or labeling to newly obtained data or to update an existing (e.g., previously obtained or processed) dataset.

The computer system includes one or more processors (e.g., processor(s) 302 in FIG. 3) and memory (e.g., memory 306). In some embodiments, the memory stores one or more programs or instructions configured for execution by the one or more processors. In some embodiments, the operations shown in FIGS. 1, 2, 4, 5A, 5B, 6A, 6B, 7A, 7B, 8, 9, and 10A to 10G correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1100 may be combined with the operations in the method 1200. The order of some operations may be changed.

Referring to FIG. 11A, the computer system obtains (operation 1102) a plurality of input images (e.g., initial data 602, reduced data 604, or input images 702) captured by one or more imaging devices (e.g., cameras 102 or cameras 110). In some embodiments, computer system obtains the input data with other modalities such as time-series data and text data.

In some embodiments, the computer system executes a data reduction process (e.g., data reduction 604) to obtain the plurality of input images. For example, in some embodiments, the computer system obtains (operation 1104) a plurality of image frames (e.g., initial data). In some embodiments, the computer system implements (operation 1106) at least one of a plurality of operations further comprising: in accordance with a determination (operation 1108) that a first set of (e.g., successive) image frames are substantially similar in brightness or in contrast, the computer system includes a subset of the first set of image frames in the plurality of input images. In some embodiments, in accordance with a determination (operation 1110) that a movement of an object is within a tolerance in a second set of image frames, the computer system includes a subset of the second set of image frames in the plurality of input images. In some embodiments, in accordance with a determination (operation 1111) that a third set of image frames are duplicative, the computer system includes one image frame of the third set of image frames in the plurality of input images while discarding (e.g., de-duplicating) remaining image frames of the third set of image frames.

In some embodiments, the computer system executes a data reduction process (e.g., data reduction 604) to obtain the plurality of input images. For example, in some embodiments, the computer system obtains (operation 1112) a plurality of image frames. In some embodiments, the computer system applies (operation 1114) one of: pixel-level image comparison (e.g., histogram-based image comparison 606), feature-based matching (e.g., feature-based matching 608), and block-based matching (e.g., block-based matching 610) to identify a third set of image frames that are substantially similar to one another. The computer system generates (operation 1116) one of the plurality of input images based on the third set of image frames. In some embodiments, the operations 1114 and 1116 are performed automatically by the computer system, without user input.

Referring to FIG. 11B, the computer system groups (operation 1120) the plurality of input images into a plurality of image clusters (e.g., a plurality of clusters of images). In some embodiments, the operation 1120 is performed automatically by the computer system, without user input. The plurality of image clusters includes a first image cluster (e.g., a first cluster of images). The first image cluster includes a first set of input images. In some embodiments, the set of input images includes at least 5,000 images, 10,000 images, 50,000 images, or 100,000 images).

In some embodiments, grouping the plurality of input images into the plurality of image clusters (e.g., multiple clusters of images) includes extracting (operation 1122) an image embedding for each of the plurality of input images (e.g., via embedding extraction 622) (e.g., as vector embeddings 806). In cases where the input data includes other data types such as time-series data and text data, the computer system can extract graph embeddings and text embeddings in the embedding extraction process. In some embodiments, the image embeddings can include low-level details (e.g., brightness and color) or high-level details (e.g., aesthetics) from the images.

In some embodiments, the computer system clusters (operation 1124) the plurality of input images into the plurality of image clusters based on a plurality of image embeddings of the plurality of input images. In some embodiments, the operation 1124 is performed automatically by the computer system, without user input. Each image cluster, or cluster of images (e.g., image cluster 706, FIG. 7B), includes a respective representative image (e.g., representative image 782) (e.g., the most representative image of the cluster of images) and a respective boundary (e.g., boundary 780). In some embodiments, the most representative image is also referred to as a centroid embedding corresponding to a centroid image (i.e., an image that is located at or near the centroid 708).

In some embodiments, grouping the plurality of input images into the plurality of image clusters includes identifying (operation 1126) a target number indicating a number of image clusters to which the plurality of image clusters belong. In some embodiments, the computer system applies a plurality of clustering methods (e.g., methods described with respect to data clustering 632) to generate a plurality of sets of image clusters (e.g., data clusters 641 or image clusters 706) based on the plurality of input images. Each clustering method corresponds to a respective set of image clusters. In some embodiments, the computer system determines (operation 1130) a plurality of clustering performance indicators (e.g., metrics or clustering KPIs, such as such as silhouette scores, the Davies-Bouldin Index, and the Calinski-Harabasz Index) for the plurality of clustering methods. In some embodiments, the computer system selects (operation 1132) one of the plurality of sets of image clusters as the plurality of image clusters. based on the plurality of clustering performance indicators. In some embodiments, selecting the one of the plurality of sets of image clusters includes determining (operation 1134) that a first cluster performance indicator is the largest among the plurality of clustering performance indicators and determining (operation 1136) that the first cluster performance indicator corresponds to the one of the plurality of sets of image clusters.

Referring to FIG. 11C, the computer system extracts (operation 1138) one or more image keywords from each input image of the first set of input images (e.g., via keyword extraction 642, keyword extraction 918, or step 720 in FIG. 7A). In some embodiments, the operation 1138 is performed automatically by the computer system, without user input. In some embodiments, the one or more keywords can be extracted from a succession of images. For example, in some embodiments, the computer system may determine, based on a series of images (e.g., consecutive images or successive images) that a person is running on the production floor based on a few images captured by the one or more cameras, and can extract the keyword “running” from the images and include that in the cluster keywords. A keyword can comprise a single word, two or more words, a phrase, or a concatenation of words, in accordance with some embodiments.

In some embodiments, for the first image cluster including the first set of input images, extracting the one or more image keywords from each of the first set of input images includes (operation 1140) generating description of the respective input image; and extracting the one or more image keywords from the description of the respective input image.

The computer system groups (operation 1142) (e.g., merges or concatenates) the one or more image keywords (e.g., via keyword merging step 922 or step 720) of each of the first set of input images to identify a plurality of cluster keywords (e.g., merged keywords 924, cluster keywords 722, or keywords for the cluster of images) of the first image cluster. In some embodiments, the computer system also determines environmental characteristics based on the plurality of cluster keywords. For example, the computer system can generate a description as “a red bottle in low light” or “a red ketchup bottle in bright light,” which describes the environmental characteristics (e.g., a light level).

In some embodiments, grouping the one or more image keywords of each of the first set of input images to identify the plurality of cluster keywords of the first image cluster includes: generating (operation 1144) (e.g., automatically and without user intervention) a collection of image keywords based on the one or more image keywords of each of the first set of input images and eliminating (operation 1146) a set of redundant keywords (and/or similar keywords) in the collection of image keywords to identify the plurality of cluster keywords.

In some embodiments, eliminating the set of redundant keywords includes identifying (operation 1148) a first subset of image keywords in the collection of image keywords; determining (operation 1150) that the first subset of image keywords are substantially similar; and generating (operation 1152) a first cluster keyword based on the first subset of image keywords.

In some embodiments, the first cluster keyword is selected from the first subset of image keywords, and remaining image keywords belong to the set of redundant keywords that is eliminated from the collection of image keywords.

In some embodiments, the first cluster keyword is generated based on the first subset of image keywords, and the first subset of image keywords belong to the set of redundant keywords that is eliminated from the collection of image keywords.

In some embodiments, “substantially similar” image keywords are keywords having a similarity level above a similarity threshold or having semantic distances among the first subset of image keywords that are smaller than a distance range, wherein the semantic distances are determined based on feature vectors extracted using machine learning models.

The computer system determines (operation 1154) a plurality of keyword weights. In some embodiments, the operation 1154 is performed automatically by the computer system, without user intervention. Each of the keyword weights is associated with a respective one cluster keyword of the plurality of cluster keywords based on cluster locations of the first set of input images in the first image cluster.

The computer system labels (operation 1156) the first set of input images based on the plurality of cluster keywords and the plurality of keyword weights. In some embodiments, the operation 1156 is performed automatically by the computer system, without user intervention.

With continued reference to FIG. 11D, in some embodiments, the computer system forms (operation 1158) (e.g., automatically, without user intervention) a corpus of training data to be used to generate a target model. In some embodiments, the generated target model is used autonomously monitoring the physical environment. The corpus of training data includes the first set of input images, each of which is labeled based on the plurality of cluster keywords and the plurality of keyword weights.

In some embodiments, the computer system, for each of the first set of input images, applies (operation 1160) an image text association model (e.g., via image-to-text processing 914) to select a respective one of the plurality of cluster keywords. The computer system forms (operation 1162) a corpus of training data to be used to generate a target model. In some embodiments, the generated target model is used autonomously monitoring the physical environment. The corpus of training data including the first set of input images each of which is labeled with the selected respective one of the plurality of cluster keywords.

In some embodiments, the computer system is configured to utilize the cluster keywords and/or keyword weights directly. For example, in some embodiments, the computer system determines (operation 1164) a plurality of feature events or objects of the first image cluster based on the plurality of cluster keywords. In some embodiments, the computer system determines (operation 1166) a plurality of occurrence rates of the plurality of feature events or objects based on the plurality of keyword weights.

Referring now to FIG. 11E, in some embodiments, a first cluster keyword corresponds to a respective image keyword of each input image in a subset of the first set of input images. In some embodiments, the computer system determines an image weight for each input image of the subset of the first set of input images based on a cluster location of the respective input image in the first image cluster. A keyword weight of the first cluster keyword is determined based on the image weight of each input image of the subset of the first set of input images.

In some embodiments, keywords extracted from images (or extracted from image cluster) that are located closer to the centroid (e.g., centroid 708) of the image cluster are assigned higher weights compared to keywords extracted from images (or extracted from image cluster) that are located further away from the centroid of the image cluster. In some embodiments, a higher weight is assigned to an input image of the subset of the first set of input images when the input image is located near the centroid of the image cluster. In some embodiments, a higher weight is assigned to an input image of the subset of the first set of input images when the input image is located near the centroid of the image cluster. In some embodiments, a lower weight is assigned to an input image of the subset of the first set of input images when the input image is located further away from the centroid of the image cluster.

In some embodiments, a respective keyword weight is a function of both its location in an image cluster and a keyword confidence level. For example, in some embodiments, the computer system determines (operation 1170) a keyword confidence level for the respective image keyword of each of the subset of the first set of input image. The keyword weight of the first cluster keyword is determined based on a combination of the image weight and the keyword confidence level of the image keyword of each input image of the subset of the first set of input images. In some embodiments, the keyword confidence level indicates a level of confidence (e.g., by the data preparation module 350) that a respective keyword accurately describes the respective image (e.g., objects, events, or context of the image) and the respective keyword is relevant to the respective image.

In some embodiments, a first cluster keyword is associated (operation 1172) with a subset of the first set of input images. In some embodiments, the computer system identifies a visual location associated with the first cluster keyword in each of the subset of the first set of input images. In some embodiments, the computer system labels each of the subset of the first set of input images with the visual location in addition to the first cluster keyword and an associated keyword weight.

Referring now to FIG. 11F, in some embodiments, the computer system executes (operation 1174) an image management application (e.g., data management application 656), including displaying a visualization user interface (e.g., GUI 658). In some embodiments, the operation 1174 is executed by the computer system automatically, without user intervention. In some embodiments, the computer system receives (operation 1176) a first user interaction, with the visualization user interface, identifying (specifying) one or more of the plurality of cluster keywords. This is illustrated in FIG. 10B. In some embodiments, the computer system, in accordance with receiving the first user interaction, displays (operation 1178) (or causes display), on the visualization user interface, a plurality of image representations (e.g., image representations 1038, 1040 or 1042) corresponding to a first subset of the first set of input images. The plurality of image representations are organized based on the one or more of the plurality of cluster keywords. In some embodiments, as illustrated in FIG. 10B, the computer system can receive another user input specifying a confidence level that the displayed images match the keywords, and adaptively displays the representation images according to the additional user input.

In some embodiments, the computer system receives (operation 1180) a second user interaction with the visualization user interface, indicating user selection of at least some of the plurality of image representations (e.g., user clicks on some images, user clicks “save” on the UI). For example, referring to FIG. 10C, the computer system can receive user selection of at least some of the plurality of image representations (e.g., image representations 1038, 1040, or 1042). In some embodiments, the computer system, in accordance with receiving the second user interaction: identifies (operation 1182) at least some input images, of the first subset of the first set of input images, corresponding to the at least some of the plurality of image representations. The computer system forms (operation 1184) a corpus of training data first using the at least some input images. The computer system applies (operation 1186) the corpus of training data to generate a model. In some embodiments, the generated model is used for autonomously monitoring the physical environment.

With continued reference to FIG. 11G, in some embodiments, the computer system executes (operation 1188) an image management application (data management application 656), including displaying a visualization user interface (e.g., GUI 658). In some embodiments, the operation 1188 is executed by the computer system automatically, without user intervention. In some embodiments, the computer system receives (operation 1190), via the visualization user interface, first user input identifying at least one of: a number of images (e.g., via user adjusting the position of indicator 1059 on the “number of images” slider tool 1058) and an image similarity level (e.g., via user adjusting the position of indicator 1061 on the “image similarity” slider 1060). In some embodiments, the computer system, in accordance with receiving the first user input, displays (operation 1192), on the visualization user interface, a plurality of image representations corresponding to a subset of the first set of input images and organized based on a respective cluster location of each input image. This is illustrated in FIGS. 10E and 10F.

In some embodiments, the computer system receives a user interaction with the visualization user interface, indicating user selection of at least a set of the plurality of image representations. For example, in FIG. 10E or FIG. 10F, the user can select (e.g., by clicking) some of the images that are displayed and hits the “Save” button on the GUI 658. In some embodiments, the computer system, in accordance with receiving the user interaction, identifies (operation 1196) at least some input images in the subset of the first set of input images, corresponding to the at least the set of the plurality of image representations. The computer system forms (operation 1197) a corpus of training data first using the at least some input images. The computer system applies (operation 1198) the corpus of training data to generate a model. In some embodiments, the generated model is used for autonomously monitoring the physical environment

It should be understood that the particular order in which the operations in FIGS. 11A to 11G have been described are merely exemplary and are not intended to indicate that the described order is the only order in which the operations could be performed. One of ordinary skill in the art would recognize various ways to dynamically generating user interfaces as described herein. Additionally, it should be noted that details of other processes described herein with respect to other figures (e.g., FIGS. 1-10F) are also applicable in an analogous manner to method 1100 described above with respect to FIGS. 11A to 11G. For brevity, these details are not repeated here.

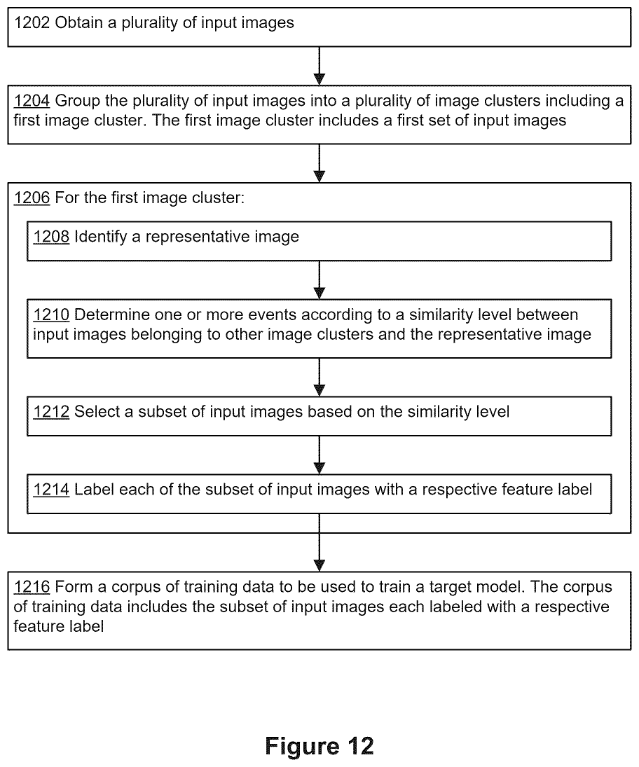

FIG. 12 provides a flowchart of an example method 1200 for automatically identifying characteristic features in data, in accordance with some embodiments. The method 1200 is performed at a computer system (e.g., computer system 300).

The computer system includes one or more processors (e.g., processor(s) 302 in FIG. 3) and memory (e.g., memory 306). In some embodiments, the memory stores one or more programs or instructions configured for execution by the one or more processors. In some embodiments, the operations shown in FIGS. 1, 2, 4, 5A, 5B, 6A, 6B, 7A, 7B, 8, 9, and 10A to 10G correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1200 may be combined with the operations in the method 1100. The order of some operations may be changed.

The computer system obtains (operation 1202) a plurality of input images (e.g., input images 702). The computer system groups (operation 1204) the plurality of input images into a plurality of image clusters (e.g., image clusters 706). The plurality of image clusters includes a first image cluster (e.g., image cluster 706-1 or image cluster 706-2). The first image cluster includes a first set of input images (e.g., set of images 707). The computer system, for (operation 1206) the first image cluster: (i) identifies (operation 1208) (e.g., automatically, without user input) a representative image (e/g, representative image 782) (e.g., the most representative image or an image located at or near the centroid 708 of the image cluster), (ii) determines (operation 1208) one or more events (e.g., outliers, unique events, or representative events) according to a similarity level between input images belonging to other image clusters and the representative image; (iii) selects (operation 1212) (e.g., automatically, without user input) a subset of input images based on the similarity level; and (iv) labels (operation 1214) (e.g., automatically, without user input) each of the subset of input images with a respective feature label. The computer system forms (operation 1216) a corpus of training data to be used to train a target model (e.g., for autonomously monitoring the physical environment). The corpus of training data includes the subset of input images each labeled with a respective feature label.

Various embodiments of this application are directed to analyzing, organizing, and labelling large data sets, automatically and with little or no user intervention. In some embodiments, the large data sets may be processed offline (e.g., after business hours of each workday). Feature events, context information, outliers, labels, and other metadata may be extracted from the large data sets to provide accurate summaries and data sketches of the large data sets. In some situations, the large data sets can be organized in a database based on the aforementioned extracted information, and facilitate further searches in the large data sets (e.g., make searches in the large data sets more efficient), thereby enhancing utilization of computational resources for management of the large data sets. In some situations, a relatively small portion (e.g., <10%) of each large data set may be selectively stored, and a large portion of the large data set is deleted, thereby conserving storage resources without causing a loss of useful information. As such, in some implementations, this application offers a solutions applied to manage data efficiently and accurately when large amounts of data are collected, thereby allowing computer systems to operate properly without being overwhelmed by the data amount or compromising their data processing performance.

It should be understood that the particular order in which the operations in FIG. 12 have been described are merely exemplary and are not intended to indicate that the described order is the only order in which the operations could be performed. One of ordinary skill in the art would recognize various ways to dynamically generating user interfaces as described herein. Additionally, it should be noted that details of other processes described herein with respect to other figures (e.g., FIGS. 1-11G) are also applicable in an analogous manner to method 1200 described above with respect to FIG. 12. For brevity, these details are not repeated here.

Turning on to some example embodiments:

(A1) In accordance with some embodiments, a method for preparing data is performed at a computer system having one or more processors and memory. The method includes (i) obtaining a plurality of input images captured by one or more imaging devices; (ii) grouping the plurality of input images into a plurality of image clusters including a first image cluster, the first image cluster including a first set of input images; (iii) extracting one or more image keywords from each of the first set of input images; (iv) grouping the one or more image keywords of each of the first set of input images to identify a plurality of cluster keywords of the first image cluster; (v) determining a plurality of keyword weights, each associated with a respective one cluster keyword of the plurality of cluster keywords based on cluster locations of the first set of input images in the first image cluster; and (vi) labelling the first set of input images based on the plurality of cluster keywords and the plurality of keyword weights.

(A2) In some embodiments of A1, the method further includes forming a corpus of training data to be used to generate a target model, the corpus of training data including the first set of input images each of which is labeled based on the plurality of cluster keywords and the plurality of keyword weights.

(A3) In some embodiments of A1 or A2, the method further includes: for each of the first set of input images, (i) applying an image text association model to select a respective one of the plurality of cluster keywords; and (ii) forming a corpus of training data to be used to generate a target model, the corpus of training data including the first set of input images each of which is labeled with the selected respective one of the plurality of cluster keywords.

(A4) In some embodiments of any of A1-A3, the method further includes determining a plurality of feature events or objects of the first image cluster based on the plurality of cluster keywords; and determining a plurality of occurrence rates of the plurality of feature events or objects based on the plurality of keyword weights.

(A5) In some embodiments of any of A1-A4, a first cluster keyword corresponds to a respective image keyword of each input image in a subset of the first set of input images. The method further includes determining an image weight for each input image of the subset of the first set of input images based on a cluster location of the respective input image in the first image cluster, where a keyword weight of the first cluster keyword is determined based on the image weight of each input image of the subset of the first set of input images.

(A6) In some embodiments of any of A5, the method includes determining a keyword confidence level for the respective image keyword of each of the subset of the first set of input image, where the keyword weight of the first cluster keyword is determined based on a combination of the image weight and the keyword confidence level of the image keyword of each input image of the subset of the first set of input images.

(A7) In some embodiments of any of A1-A6, a first cluster keyword is associated with a subset of the first set of input images. The method further includes: (i) identifying a visual location associated with the first cluster keyword in each of the subset of the first set of input images; and (ii) labelling each of the subset of the first set of input images with the visual location in addition to the first cluster keyword and an associated keyword weight.

(A8) In some embodiments of any of A1-A7, grouping the plurality of input images into the plurality of image clusters further includes: extracting an image embedding for each of the plurality of input images; and clustering the plurality of input images into the plurality of image clusters based on a plurality of image embeddings of the plurality of input images, each image cluster having a respective most representative image and a respective boundary.

(A9) In some embodiments of any of A1-A8, grouping the plurality of input images into the plurality of image clusters further includes: (i) identifying a target number indicating a number of image clusters to which the plurality of image clusters belong; (ii) applying a plurality of clustering methods to generate a plurality of sets of image clusters based on the plurality of input images, each clustering method corresponding to a respective set of image clusters; (iii) determining a plurality of clustering performance indicators for the plurality of clustering methods; and (iv) based on the plurality of clustering performance indicators, selecting one of the plurality of sets of image clusters as the plurality of image clusters.

(A10) In some embodiments of A9, selecting the one of the plurality of sets of image clusters further includes: (i) determining that a first cluster performance indicator is the largest among the plurality of clustering performance indicators; and (ii) determining that the first cluster performance indicator corresponds to the one of the plurality of sets of image clusters.

(A11) In some embodiments of any of A1-A10, grouping the one or more image keywords of each of the first set of input images to identify the plurality of cluster keywords of the first image cluster further includes: (i) generating a collection of image keywords based on the one or more image keywords of each of the first set of input images; and (ii) eliminating a set of redundant keywords in the collection of image keywords to identify the plurality of cluster keywords.

(A12) In some embodiments of A11, eliminating the set of redundant keywords further includes: (i) identifying a first subset of image keywords in the collection of image keywords: (ii) determining that the first subset of image keywords are substantially similar; and (iii) generating a first cluster keyword based on the first subset of image keywords.

(A13) In some embodiments of any of A1-A12, obtaining a plurality of input images further includes: (i) obtaining a plurality of image frames; and (ii) implementing at least one of a plurality of operations further comprising: (a) in accordance with a determination that a first set of image frames are substantially similar in brightness or in contrast, including a subset of the first set of image frames in the plurality of input images; (b) in accordance with a determination that a movement of an object is within a tolerance in a second set of image frames, including a subset of the second set of image frames in the plurality of input images; and (c) in accordance with a determination that a third set of image frames are duplicative, including one image frame of the third set of image frames in the plurality of input images while discarding remaining image frames of the third set of image frames.

(A14) In some embodiments of any of A1-A13, obtaining a plurality of input images further includes: (i) obtaining a plurality of image frames; (ii) applying one of pixel-level image comparison, feature-based matching, and block-based matching to identify a third set of image frames that are substantially similar to one another; and (iii) generating one of the plurality of input images based on the third set of image frames.

(A15) In some embodiments of any of A1-A14, for the first image cluster including the first set of input images, extracting the one or more image keywords from each of the first set of input images further includes: (i) generating description of the respective input image; and (ii) extracting the one or more image keywords from the description of the respective input image.

(A16) In some embodiments of any of A1-A15, the method further includes (i) executing an image management application, including displaying a visualization user interface; (ii) receiving a first user interaction, with the visualization user interface, identifying one or more of the plurality of cluster keywords; and (iii) in accordance with receiving the first user interaction: displaying, on the visualization user interface, a plurality of image representations corresponding to a first subset of the first set of input images, the plurality of image representations organized based on the one or more of the plurality of cluster keywords.

(A17) In some embodiments of A16, the method further includes: (i) receiving a second user interaction with the visualization user interface, indicating user selection of at least some of the plurality of image representations; and (ii) in accordance with receiving the second user interaction: (a) identifying at least some input images, of the first subset of the first set of input images, corresponding to the at least some of the plurality of image representations; (b) forming a corpus of training data first using the at least some input images; and (c) applying the corpus of training data to generate a model.

(A18) In some embodiments of any of A1-A17, the method further includes: (i) executing an image management application, including displaying a visualization user interface; (ii) receiving, via the visualization user interface, first user input identifying at least one of: a number of images and an image similarity level; and (iii) in accordance with receiving the first user input: displaying, on the visualization user interface, a plurality of image representations corresponding to a subset of the first set of input images and organized based on a respective cluster location of each input image.

(A19) In some embodiments of A18, the method further includes: (i) receiving a user interaction with the visualization user interface, indicating user selection of at least a set of the plurality of image representations; and (ii) in accordance with receiving the user interaction: (a) identifying at least some input images in the subset of the first set of input images, corresponding to the at least the set of the plurality of image representations; (b) forming a corpus of training data first using the at least some input images; and (c) applying the corpus of training data to generate a model.

(B1) In accordance with some embodiments, a method for automatically identifying characteristic features in data is performed at a computer system having one or more processors and memory. The method includes (i) obtaining a plurality of input images; (ii) grouping the plurality of input images into a plurality of image clusters including a first image cluster, the first image cluster including a first set of input images; (iii) for the first image cluster: (a) identifying a representative image; (b) determining one or more events according to a similarity level between input images belonging to other image clusters and the representative image; (c) selecting a subset of input images based on the similarity level; and (d) labelling each of the subset of input images with a respective feature label; and (iv) forming a corpus of training data to be used to train a target model, the corpus of training data including the subset of input images each labeled with a respective feature label.

(C1) In accordance with some embodiments, a computer system comprises one or more processors and memory. The memory stores one or more programs for execution by the one or more processors. The one or more programs include instructions for performing the method of any of A1-A19 and B1.

(D1) In accordance with some embodiments, a non-transitory computer-readable storage medium, stores one or more programs for execution by one or more processors of a computer system. The one or more programs include instructions for performing for performing the method of any of A1-A19 and B1.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

It is also to be appreciated that while the terms user may be used to refer to the person or persons acting in the context of some particular situations described herein, these references do not limit the scope of the present teachings with respect to the person or persons who are performing such actions. Importantly, while the identity of the person performing the action may be germane to a particular advantage provided by one or more of the implementations, such identity should not be construed in the descriptions that follow as necessarily limiting the scope of the present teachings to those particular individuals having those particular identities.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for preparing data, comprising:
at a computer system having one or more processors and memory:
obtaining a plurality of input images captured by one or more imaging devices;
grouping the plurality of input images into a plurality of image clusters including a first image cluster, the first image cluster including a first set of input images;
extracting one or more image keywords from each of the first set of input images;
grouping the one or more image keywords of each of the first set of input images to identify a plurality of cluster keywords of the first image cluster;
determining a plurality of keyword weights, each associated with a respective one cluster keyword of the plurality of cluster keywords based on cluster locations of the first set of input images in the first image cluster; and
labelling the first set of input images based on the plurality of cluster keywords and the plurality of keyword weights.

2. The method of claim 1, further comprising:
forming a corpus of training data to be used to generate a target model, the corpus of training data including the first set of input images, each of which is labeled based on the plurality of cluster keywords and the plurality of keyword weights.

3. The method of claim 1, further comprising:
for each of the first set of input images, applying an image text association model to select a respective one of the plurality of cluster keywords; and
forming a corpus of training data to be used to generate a target model, the corpus of training data including the first set of input images, each of which is labeled with the selected respective one of the plurality of cluster keywords.

4. The method of claim 1, further comprising:
determining a plurality of feature events or objects of the first image cluster based on the plurality of cluster keywords; and
determining a plurality of occurrence rates of the plurality of feature events or objects based on the plurality of keyword weights.

5. The method of claim 1, wherein a first cluster keyword corresponds to a respective image keyword of each input image in a subset of the first set of input images, the method further comprising:
determining an image weight for each input image of the subset of the first set of input images based on a cluster location of the respective input image in the first image cluster;
wherein a keyword weight of the first cluster keyword is determined based on the image weight of each input image of the subset of the first set of input images.

6. The method of claim 5, further comprising:
determining a keyword confidence level for the respective image keyword of each of the subset of the first set of input image;
wherein the keyword weight of the first cluster keyword is determined based on a combination of the image weight and the keyword confidence level of the respective image keyword of each input image of the subset of the first set of input images.

7. The method of claim 1, wherein a first cluster keyword is associated with a subset of the first set of input images, the method further comprising:
identifying a visual location associated with the first cluster keyword in each of the subset of the first set of input images; and
labelling each of the subset of the first set of input images with the visual location in addition to the first cluster keyword and an associated keyword weight.

8. A computer system, comprising:
one or more processors; and
memory storing one or more programs for execution by the one or more processors, the one or more programs further comprising instructions for:
obtaining a plurality of input images captured by one or more imaging devices;
grouping the plurality of input images into a plurality of image clusters including a first image cluster, the first image cluster including a first set of input images;
extracting one or more image keywords from each of the first set of input images;
grouping the one or more image keywords of each of the first set of input images to identify a plurality of cluster keywords of the first image cluster;
determining a plurality of keyword weights, each associated with a respective one cluster keyword of the plurality of cluster keywords based on cluster locations of the first set of input images in the first image cluster; and
labelling the first set of input images based on the plurality of cluster keywords and the plurality of keyword weights.

9. The computer system of claim 8, wherein the instructions for grouping the plurality of input images into the plurality of image clusters further include instructions for:
extracting an image embedding for each of the plurality of input images; and
clustering the plurality of input images into the plurality of image clusters based on a plurality of image embeddings of the plurality of input images, each image cluster having a respective most representative image and a respective boundary.

10. The computer system of claim 8, wherein the instructions for grouping the plurality of input images into the plurality of image clusters further include instructions for:
identifying a target number indicating a number of image clusters to which the plurality of image clusters belong;
applying a plurality of clustering methods to generate a plurality of sets of image clusters based on the plurality of input images, each clustering method corresponding to a respective set of image clusters;
determining a plurality of clustering performance indicators for the plurality of clustering methods; and
based on the plurality of clustering performance indicators, selecting one of the plurality of sets of image clusters as the plurality of image clusters.

11. The computer system of claim 10, wherein the instructions for selecting the one of the plurality of sets of image clusters further include instructions for:
determining that a first cluster performance indicator is the largest among the plurality of clustering performance indicators; and
determining that the first cluster performance indicator corresponds to the one of the plurality of sets of image clusters.

12. The computer system of claim 8, wherein the instructions for grouping the one or more image keywords of each of the first set of input images to identify the plurality of cluster keywords of the first image cluster further include instructions for:
generating a collection of image keywords based on the one or more image keywords of each of the first set of input images; and
eliminating a set of redundant keywords in the collection of image keywords to identify the plurality of cluster keywords.

13. The computer system of claim 12, wherein the instructions for eliminating the set of redundant keywords further include instructions for:
identifying a first subset of image keywords in the collection of image keywords:
determining that the first subset of image keywords are substantially similar; and
generating a first cluster keyword based on the first subset of image keywords.

14. The computer system of claim 8, wherein the instructions for obtaining the plurality of input images further include instructions for:
obtaining a plurality of image frames; and
implementing at least one of a plurality of operations further comprising:
in accordance with a determination that a first set of image frames are substantially similar in brightness or in contrast, including a subset of the first set of image frames in the plurality of input images;
in accordance with a determination that a movement of an object is within a tolerance in a second set of image frames, including a subset of the second set of image frames in the plurality of input images; and
in accordance with a determination that a third set of image frames are duplicative, including one image frame of the third set of image frames in the plurality of input images while discarding remaining image frames of the third set of image frames.

15. The computer system of claim 8, wherein the instructions for obtaining the plurality of input images further include instructions for:
obtaining a plurality of image frames;
applying one of pixel-level image comparison, feature-based matching, and block-based matching to identify a third set of image frames that are substantially similar to one another; and
generating one of the plurality of input images based on the third set of image frames.

16. A non-transitory computer-readable storage medium, storing one or more programs for execution by one or more processors, the one or more programs comprising instructions for:
obtaining a plurality of input images captured by one or more imaging devices;
grouping the plurality of input images into a plurality of image clusters including a first image cluster, the first image cluster including a first set of input images;
extracting one or more image keywords from each of the first set of input images;
grouping the one or more image keywords of each of the first set of input images to identify a plurality of cluster keywords of the first image cluster;
determining a plurality of keyword weights, each associated with a respective one cluster keyword of the plurality of cluster keywords based on cluster locations of the first set of input images in the first image cluster; and
labelling the first set of input images based on the plurality of cluster keywords and the plurality of keyword weights.

17. The non-transitory computer-readable storage medium of claim 16, wherein for the first image cluster including the first set of input images, the instructions for extracting the one or more image keywords from each of the first set of input images further include instructions for:
generating description of the respective input image; and
extracting the one or more image keywords from the description of the respective input image.

18. The non-transitory computer-readable storage medium of claim 16, the one or more programs further comprising instructions for:
executing an image management application, including displaying a visualization user interface;
receiving a first user interaction, with the visualization user interface, identifying one or more of the plurality of cluster keywords; and
in accordance with receiving the first user interaction:
displaying, on the visualization user interface, a plurality of image representations corresponding to a first subset of the first set of input images, the plurality of image representations organized based on the one or more of the plurality of cluster keywords.

19. The non-transitory computer-readable storage medium of claim 18, the one or more programs further comprising instructions for:
receiving a second user interaction with the visualization user interface, indicating user selection of at least some of the plurality of image representations; and
in accordance with receiving the second user interaction:
identifying at least some input images, of the first subset of the first set of input images, corresponding to the at least some of the plurality of image representations;
forming a corpus of training data first using the at least some input images; and
applying the corpus of training data to generate a model.

20. The non-transitory computer-readable storage medium of claim 16, the one or more programs further comprising instructions for:
executing an image management application, including displaying a visualization user interface;
receiving, via the visualization user interface, a first user input identifying at least one of: a number of images and an image similarity level; and
in accordance with receiving the first user input:
displaying, on the visualization user interface, a plurality of image representations corresponding to a subset of the first set of input images and organized based on a respective cluster location of each input image.
